(19) United States
(12) Patent Application Publication
(10) Pub. No.: US 2024/0332626 A1
(43) Pub. Date: Oct. 3, 2024

(54) RECHARGEABLE BATTERY CELL

(71) Applicant: Innolith Technology AG, Basel (CH)

(72) Inventors: Laurent Zinck, Mothern (FR); Markus Borck, Stuttgart (DE); Claudia Wollfarth, Karlsruhe (DE); Julia Thümmel, Bruchsal-Untergrombach (DE)

(21) Appl. No.: 18/744,147

(22) Filed: Jun. 14, 2024

Related U.S. Application Data
(63) Continuation of application No. PCT/EP2022/085939, filed on Dec. 14, 2022.

(30) Foreign Application Priority Data
Dec. 17, 2021 (EP) 21 215 537.8

(51) Int. Cl. H01M 10/0568; H01M 10/0525

(52) U.S. Cl. CPC H01M 10/0568; H01M 10/0525; H01M 2300/0025

(57) ABSTRACT

A rechargeable battery cell contains an active metal, at least one positive electrode with a conducting element, at least one negative electrode with a conducting element, at least one separator element, a housing, and an electrolyte. The electrolyte is based on SO₂ and contains at least a first conductive salt which has the formula (I)

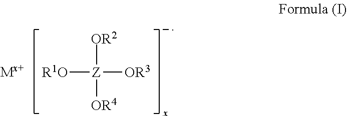

M can be an alkali metal, alkaline earth metal, metals of group 12 of the periodic table of the elements and aluminum; x is an integer from 1 to 3; R¹, R², R³ and R⁴ can be C₁-C₁₀ alkyl, C₂-C₁₀ alkenyl, C2-C₁₀ alkynyl, C₃-C₁₀ cycloalkyl, C₆-C₁₄ aryl and C₅-C₁₄ heteroaryl. The aliphatic, cyclic, aromatic and heteroaromatic groups can be unsubstituted or substituted. Z is aluminum or boron. At least two of R¹, R², R³ and R⁴ can jointly form a chelate ligand coordinated to Z. The active metal is in metallic form in the charged state of the rechargeable battery cell. A space for receiving the active metal deposited during the charging process is arranged within the housing, which is formed by a compressible structure, which is compressed by the deposited active metal.

### RELATED APPLICATIONS

This application is a continuation of PCT/EP2022/085939, filed Dec. 14, 2022, which claims priority to EP 21 215 537.8, filed Dec. 17, 2021, the entire disclosures of both of which are hereby incorporated herein by reference.

### BACKGROUND

This disclosure relates to a rechargeable battery cell with a compressible structure.

Rechargeable battery cells are of great importance in many technical fields. They are often used for applications that only require small, rechargeable battery cells with relatively low current levels, such as mobile phones. In addition, however, there is also a great need for larger, rechargeable battery cells for high-energy applications, with a mass storage of energy in the form of battery cells for electrically driven vehicles being of particular importance.

One important requirement for such rechargeable battery cells is a high energy density. This means that the rechargeable battery cell should contain as much electrical energy as possible per unit of weight and volume. Lithium has proven to be particularly advantageous as the active metal for this purpose.

The metal whose ions migrate within the electrolyte to the negative or positive electrode during the charging or discharging of the cell and that take part in electrochemical processes there are referred to as active metal. Rechargeable battery cells that contain active metal in a metallic form are referred to as metal cells. Metals that can be contained in a battery cell in a metallic form are, for example, alkali metals, in particular lithium or sodium, alkaline earth metals, in particular calcium, or metals from group 12 of the periodic table, in particular zinc or aluminum. Rechargeable battery cells that contain metallic lithium or metallic sodium as the active material of the negative electrode are then referred to as lithium cells or sodium cells.

The positive electrodes of the metal cells known from prior art are designed as insertion electrodes. The term “insertion electrode” in the context of this disclosure is understood to refer to electrodes that have a crystal structure in which ions of the active metal can be intercalated and from which ions of the active metal can be deintercalated during the operation of the metal cell. This means that the electrode processes can take place not only on the surface of the electrode, but also within the crystal structure. The positive electrode, for example, consists of lithium cobalt oxide (LiCoO₂). When charging the lithium cell, the ions of the active metal are deintercalated from the positive electrode and intercalated on the negative electrode as metallic lithium. The reverse process occurs when the lithium cell is discharged.

The electrolyte is also an important functional element of every rechargeable battery cell. It usually contains a solvent or a mixture of solvents and at least one conductive salt. Solid electrolytes or ionic liquids, for example, do not contain any solvent, only the conductive salt. The electrolyte is in contact with the positive and negative electrodes of the battery cell. At least one ion of the conductive salt (anion or cation) is mobile in the electrolyte in such a way that ion conduction allows a charge transport to occur between the electrodes, which is necessary for the functioning of the rechargeable battery cell. Above a certain upper cell voltage of the rechargeable battery cell, the electrolyte is electrochemically decomposed by oxidation. This process often leads to an irreversible destruction of electrolyte components and thus to a failure of the rechargeable battery cell. Reductive processes can also decompose the electrolyte above a certain lower cell voltage. In order to avoid these processes, the positive and negative electrodes are selected in such a way that the cell voltage is below or above the decomposition voltage of the electrolyte. The electrolyte thus determines the voltage window in which a rechargeable battery cell can be operated reversibly, that is (i.e.), repeatedly charged and discharged.

The lithium cells or sodium cells known from prior art contain an electrolyte which comprises an organic solvent or solvent mixture and a conductive salt dissolved therein. The conductive salt is a lithium salt such as lithium hexafluorophosphate (LiPF₆), for example, or a sodium salt such as sodium hexafluorophosphate (NaPF₆). The solvent mixture can contain ethylene carbonate, for example. The electrolyte LP57, which has the composition 1M LiPF₆ in EC (ethylene carbonate):EMC (ethyl methyl carbonate) 3:7, is an example of such an electrolyte. Due to the organic solvent or solvent mixture, such battery cells are also called organic battery cells.

Other conductive salts for organic lithium-ion cells are also described in addition to the lithium hexafluorophosphate (LiPF₆) that is frequently used as a conductive salt in prior art. For example, the document JP 4 306 858 B2 (hereinafter referred to as [V1]) describes conductive salts in the form of tetraalkoxy or tetraaryloxyborate salts, which can be fluorinated or partially fluorinated.

JP 2001 143750 A (referred to below as [V2]) reports on fluorinated or partially fluorinated tetraalkoxyborate salts and tetraalkoxyaluminate salts as conductive salts. In both documents [V1] and [V2], the conductive salts described are dissolved in organic solvents or solvent mixtures and used in organic lithium-ion cells.

However, battery cells with electrolytes based on organic solvents are very sensitive to overcharging. An unintentional overcharging, i.e., increasing the voltage above the maximum cell voltage, of organic battery cells leads to an irreversible oxidative and reductive decomposition of electrolyte components and thus has a detrimental effect on the service life of the battery cell. In this case, the oxidative decomposition of the organic solvent and/or the conductive salt takes place on the surface of the positive electrode. The heat of reaction generated during this decomposition and the resulting gaseous products are responsible for the subsequent so-called “thermal runaway” and the resulting destruction of the organic battery cell. The vast majority of charging protocols, for example, for organic lithium-ion cells, use cell voltage as an indicator of end-of-charge.

Thermal runaway accidents are particularly likely when using multi-cell battery packs, in which several organic lithium cells with mismatched capacities are connected in series.

The reductive decomposition of the organic electrolyte of an organic battery cell takes place at the negative electrode and is irreversible as well.

No organic solvents are thermodynamically stable, for example, against lithium or sodium, which is stored in carbon. However, many solvents form a passivation film on the electrode surface of the negative electrode. This film spatially separates the solvent from the electrode, but is ionically conductive and thus allows the passage of lithium ions or sodium ions. The passivation film, the so-called “Solid Electrolyte Interphase” (SEI), gives the system stability, which allows for the production of, for example, lithium cells or sodium cells. During the formation of the SEI, lithium or sodium is integrated into the passivation film. This process is irreversible and is therefore seen as a loss of capacity. Therefore, organic metal cells are problematic in terms of their stability and long-term operational reliability. Safety risks are also caused in particular by the flammability of the organic solvent or solvent mixture. If an organic metal cell catches fire or even explodes, the metallic active metal forms a highly reactive substance and the organic solvent of the electrolyte a combustible material. In order to avoid such safety risks, additional measures must be taken. However, the additional measures are considered to be detrimental to any possible marketing.

A further development known from prior art provides for the use of an electrolyte based on sulfur dioxide (SO₂) instead of an organic electrolyte for rechargeable battery cells. Rechargeable battery cells which contain an SO₂-based electrolyte have, among other things, a high ionic conductivity. The context of this disclosure, the term “SO₂-based electrolyte” is to be understood as meaning an electrolyte that not only contains SO₂ as an additive at a low concentration, but in which the mobility of the ions of the conductive salt contained in the electrolyte, the salt effecting the charge transport, is at least partially, largely or even fully ensured by SO₂. The SO₂ thus serves as a solvent for the conductive salt. The conductive salt can form a liquid solvate complex with the gaseous SO₂, making it possible for the SO₂ to be bound and the vapor pressure to be noticeably reduced compared to pure SO₂. This results in electrolytes with a low vapor pressure. Such electrolytes based on SO₂ have the advantage of non-combustibility compared to the organic electrolytes described above. Safety risks which are due to the flammability of the electrolyte can be ruled out this way.

In addition to the above-mentioned disadvantages of organic battery cells, the use of the metallic active metal of the negative electrode in rechargeable metal cells results in further problems as well. On the one hand, the active metal is not deposited uniformly during the charging process, but in the form of dendrites. The uncontrollable dendrite growth leads to an accumulation of a highly reactive metal with a large surface area, which can lead to safety-critical conditions. On the other hand, the thermodynamic instability of, for example, metallic lithium or metallic sodium causes irreversible and continuous reactions between them and the electrolyte. For example, in lithium cells, unintentionally thick passivation layers (SEI) are formed on the lithium metal surface, which consume lithium and electrolyte components. During the repeated charging and discharging, large volumetric and morphological changes can occur in the lithium metal anode. The above-mentioned SEI films are too unstable to completely suppress such significant changes. This increases the internal resistance and shortens the service life of the rechargeable lithium battery cell.

The increase in volume within a metal cell due to the deposition of solid active metal from the previously dissolved ions can also lead to voltages and pressure increases within the housing during the charging process. This can damage the electrodes, the separator or even the housing itself.

The disadvantages and problems mentioned are serious, which is why research is currently being carried out to find solutions to these problems in connection with a metallic anode, both for organic metal cells and for metal cells with an SO₂-based electrolyte, as can be seen, for example, from the following documents.

The authors of the document [V3] (“Dendrite-Free Lithium Deposition Induced by Uniformly Distributed Lithium Ions for Efficient Lithium Metal Batteries” Cheng et al., Adv. Mater. 2016, 28, 2888-2895) discuss a lithium metal battery with an organic electrolyte. To obtain a dendrite-free lithium metal anode, they use a 3D glass fiber fabric with a large number of polar groups to deposit lithium.

The authors of the document [V4] (“Design Strategies to Enable the Efficient Use of Sodium Metal Anodes in High-Energy Batteries” Sun et al., Adv. Mater. 2020, 32, 1903891) describe various methods to prevent a dendritic deposition of sodium in organic sodium cells, such as the appropriate adaptation of liquid electrolytes, solid-state electrolytes or the Na metal anode/electrolyte interface. They discuss nanostructured sodium metal anodes as well.

The authors Oh et al. of the article in the JOURNAL OF POWER SOURCES, Vol. 68, No. 2, Oct. 1, 1997 (Oct. 1, 1997), pages 338-343 (referred to as [V5]) discuss a rechargeable lithium metal cell with the combination Li/LiₓCoO₂ and with a LiAlCl₄·3SO₂ electrolyte. To prevent the degradation of the lithium metal electrode, the authors suggest adding small amounts of LiPF₆ to the electrolyte.

U.S. Pat. No. 7,901,811 B2 (hereinafter referred to as [V6]) describes a lithium metal cell with an SO₂-based electrolyte with the conductive salt lithium tetrachloroaluminate (LiAlCl₄). In order to avoid the disadvantages of the dendritic deposition, a porous structure formed from solid particles is proposed, which is designed and arranged in such a way that the lithium deposited during the charging of the lithium metal cell penetrates from the surface of the arrester into the pores of the porous structure and is further deposited there.

In addition to the alkali tetrachloroaluminate conducting salts commonly used in SO₂ electrolytes (e.g. LiAlCl₄*xSO₂ or NaAlCl₄*xSO₂), WO 2021/019047 A1 (hereinafter referred to as [V6]) discloses a new group of conducting salts for SO₂-based electrolytes. These conducting salts consist of an anion with four substituted hydroxy groups grouped around the central atom boron or aluminum and a cation consisting of the active metal of the cell. [V7] also reports on a homogeneous lithium deposition in SO₂-based electrolytes with these conducting salts.

However, the solutions known from prior art are not sufficient to overcome all the problems mentioned. Thus, the object underlying this disclosure is to provide a rechargeable battery cell with an SO₂-based electrolyte, which has improved electrical performance data, in particular a high energy density and
that allows for a deposition of metallic active metal that is as uniform as possible;
does not cause any increase in pressure during the deposition of active metal within the battery housing;
comprises a stable cover layer on the negative electrode, wherein the cover layer capacity should be low and no further reductive electrolyte decomposition should occur on the negative electrode during further operation;
is robust against various abuses such as electrical, mechanical or thermal;
has a wide electrochemical window so that oxidative electrolyte decomposition does not occur at the positive electrode;
has an improved overcharge capability and deep discharge capability and a lower self-discharge and
has an increased service life, in particular a high number of serviceable charging and discharging cycles.

Such rechargeable battery cells should in particular also have very good electrical energy and performance data, high operational reliability and service life, in particular a large number of serviceable charging and discharging cycles, without the electrolyte decomposing during operation of the rechargeable battery cell.

The object underlying this disclosure was surprisingly achieved by a rechargeable battery cell having the features of claim 1. Claims 2 to 20 describe advantageous developments of the rechargeable battery cell according to this disclosure. Further advantageous developments of the rechargeable battery cell according to this disclosure can be found in the description, the examples and the drawings.

A rechargeable battery cell according to this disclosure comprises an active metal, at least one positive electrode with a conducting element, at least one negative electrode with a conducting element, at least one separator element, a housing and an electrolyte, wherein the electrolyte is based on SO₂ and contains at least a first conductive salt which has the formula (I)

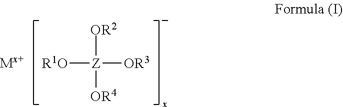

In formula (I), M is a metal selected from the group consisting of alkali metals, alkaline earth metals, metals from group 12 of the periodic table of elements, and aluminum. x is an integer from 1 to 3. The substituents R¹, R², R³ and R⁴ are independently selected from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl, wherein the aliphatic, cyclic, aromatic and heteroaromatic groups may be unsubstituted or substituted. The central atom Z is either aluminum or boron. At least two of the substituents R¹, R², R³ and R⁴ can jointly form a chelate ligand which is coordinated to Z. Furthermore, the negative electrode contains the active metal in metallic form, at least when the rechargeable battery cell is in the charged state. In addition, a space for receiving the active metal deposited during the charging process is arranged within the housing. This space is formed by a compressible structure that is compressed by the deposited active metal.

The SO₂-based electrolyte used in the rechargeable battery cell according to this disclosure contains SO₂ not only as an additive at a low concentration, but also at concentrations at which the mobility of the ions of the first conductive salt, which is contained in the electrolyte and effects the charge transport, is at least partially, largely or even fully ensured by the SO₂. The first conductive salt is dissolved in the electrolyte and exhibits very good solubility therein. It can form a liquid solvate complex with the gaseous SO₂, the SO₂ being bound in said complex. In this case, the vapor pressure of the liquid solvate complex drops significantly compared to pure SO₂ and electrolytes with a low vapor pressure result. However, it is also within the scope of this disclosure that, depending on the chemical structure of the first conductive salt according to formula (I), no reduction in vapor pressure can occur during the production of the electrolyte according to this disclosure. In the latter case, it is preferred that the electrolyte according to this disclosure is produced at low temperature or under pressure. The electrolyte can also contain a plurality of conductive salts of formula (I) which differ from one another in their chemical structure.

In the context of this disclosure, the term “C₁-C₁₀ alkyl” comprises linear or branched saturated hydrocarbon groups having one to ten carbon atoms. These include, in particular, methyl, ethyl, n-propyl, isopropyl, n-butyl, sec-butyl, isobutyl, tert-butyl, n-pentyl, isopentyl, 2,2-dimethylpropyl, n-hexyl, isohexyl, 2-ethylhexyl, n-heptyl, isoheptyl, n-octyl, isooctyl, n-nonyl, n-decyl and the like.

In the context of this disclosure, the term “C₂-C₁₀ alkenyl” includes unsaturated linear or branched hydrocarbon groups having two to ten carbon atoms, the hydrocarbon groups having at least one C—C double bond. These include in particular ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl, 1-decenyl and the like.

In the context of this disclosure, the term “C₂-C₁₀ alkynyl” includes unsaturated linear or branched hydrocarbon groups having two to ten carbon atoms, the hydrocarbon groups having at least one C—C triple bond. These include in particular ethynyl, 1-propynyl, 2-propynyl, 1-n-butynyl, 2-n-butynyl, isobutynyl, 1-pentynyl, 1-hexynyl, 1-heptynyl, 1-octynyl, 1-nonynyl, 1-decynyl and the like.

In the context of this disclosure, the term “C₃-C₁₀ cycloalkyl” includes cyclic, saturated hydrocarbon groups having three to ten carbon atoms. These include, in particular, cyclopropyl, cyclobutyl, cyclopentyl, cyclohexyl, cycloheptyl, cyclohexyl, cyclononyl and cyclodecanyl.

In the context of this disclosure, the term “C₆-C₁₄ aryl” includes aromatic hydrocarbon groups having six to fourteen carbon atoms in the ring. These include in particular phenyl (C₆H₅ group), naphthyl (C₁₀H₇ group) and anthracyl (C₁₄H₉ group).

In the context of this disclosure, the term “C₅-C₁₄ heteroaryl” includes aromatic hydrocarbon groups with five to fourteen ring hydrocarbon atoms in which at least one hydrocarbon atom is replaced or exchanged by a nitrogen, oxygen or sulfur atom. These include in particular pyrrolyl, furanyl, thiophenyl, pyrridinyl, pyranyl, thiopyranyl and the like. All of the aforementioned hydrocarbon groups are bonded to the central atom of the formula (I) via the oxygen atom, respectively.

In all the definitions of the terms already mentioned, it is also within the meaning of this disclosure that the aliphatic, cyclic, aromatic and heteroaromatic residues/groups can be unsubstituted or substituted. During the substitution, one or more hydrogen atoms of the aliphatic, cyclic, aromatic and heteroaromatic residues/groups are replaced by an atom, such as fluorine or chlorine, or a chemical group, such as CF₃.

The formulation “chelate ligand which is formed jointly by at least two of the substituents R¹, R², R³ and R⁴ and is coordinated to Z” is to be understood with regard to this disclosure that at least two of the substituents R¹, R², R³ and R⁴ can be bridged to one another, wherein this bridging of two substituents leads to the formation of a bidentate chelate ligand. Such chelate ligands can, for example, have the following structural formulas:

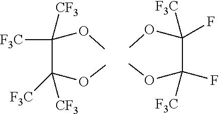

The chelate ligand coordinates to the central atom Z to form a chelate complex. In the case of the bidentate chelate ligand, the two oxygen atoms coordinate to the central atom Z. Such chelate complexes can be prepared synthetically as described in Example 1 below. The term “chelate complex”—also referred to as chelate for short—stands for complex compounds in which a multidentate ligand (has more than one free electron pair) occupies at least two coordination sites (bonding sites) of the central atom. The chelate ligand can also be multidentate if three or four of the substituents R¹, R², R³ and R⁴ are bridged to each other.

The term “space for receiving metallic active metal” refers to a volume that absorbs the amounts of metallic active metal deposited during the charging of the battery cell. During the charging, metallic active metal is deposited on the conducting element of the negative electrode leading to an increase in volume.

The rechargeable battery cell according to this disclosure provides that the space for receiving the deposited active metal is formed by one or more compressible structures which are compressed by the active metal deposited during the charging of the battery cell. This embodiment according to this disclosure has the considerable advantage that it ensures that neither the conducting element of the negative electrode nor the negative electrode or even the housing itself are damaged due to the increase in volume within the battery cell. At the same time, the compressible structure exerts pressure on the depositing active metal, which contributes to the deposition of the active metal in a compact form.

It is within the meaning of this disclosure that the rechargeable battery cell according to this disclosure has one or more compressible structures. For the sake of simplicity, the following discussion will focus on a battery cell with one compressible structure. The same applies to battery cells that contain a plurality of compressible structures.

When the active metal is completely deposited, a metal layer with a thickness o is formed. The compressible structure has a layer thickness p in the uncompressed state and a layer thickness q in the maximally compressed state. In one advantageous development of the rechargeable battery cell according to this disclosure, the thickness o of the deposited metal layer together with the thickness q of the compressed structure in the compressed state is less than or equal to the thickness p of the compressible structure in the uncompressed state, as can be seen from the equation below:

$$o + q <= p$$

Generally speaking, the sum of the thickness of the deposited metal layer and the thickness of the compressed structure in the compressed state is less than or equal to the thickness of the compressible structure in the uncompressed state, thus ensuring that no increase in volume occurs in the battery cell according to this disclosure.

Accordingly, for a battery cell with a plurality of compressible structures, the compressible structures 1 to n have the total layer thickness of p=p1+p2+ . . . +pn in the uncompressed state and the total layer thickness of q=q1+q2+ . . . +qn in the maximally compressed state. If the metal deposition occurs within a battery cell at 1 to n locations, e.g., on both sides of a conducting element or on a plurality of conducting elements, then the total thickness o of the deposited metal layers is calculated as o=o1+o2+ . . . +on.

One advantageous development of the rechargeable battery cell according to this disclosure provides that the compressible structure can be reduced to at least 90%, preferably at least 70%, more preferably at least 50%, even more preferably at least 30% and most preferably at least 10% of its original thickness.

A further advantageous development of the rechargeable battery cell according to this disclosure provides that the compressible structure is selected such that it returns to its uncompressed state after the dissolution of the previously deposited active metal. This advantageous development of the rechargeable battery cell according to this disclosure ensures that no free spaces arise that could have a detrimental effect on the structure of the battery cell.

A further advantageous development of the rechargeable battery cell according to this disclosure provides that the compressible structure comprises a polymer. For the purposes of this disclosure, structures which reversibly compress and expand again are, for example, structures made of:
woven polymers,
polymer films,
non-woven polymers,
polymer membranes or
inorganic fleeces e.g., glass fiber fleeces

This disclosure is not limited to the examples mentioned, however.

A further advantageous development of the rechargeable battery cell according

to this disclosure provides that the compressible structure is formed by at least one conducting element and/or by at least one separator element.

### Separator Element

A further advantageous development of the rechargeable battery cell according to this disclosure provides that the compressible structure is formed by at least one separator element, the so-called compressible separator element.

The separator element is an important functional element of every battery cell. Its job is to electrically isolate the positive and the negative electrodes of the battery cell. At the same time, it ensures that charge transport between the electrodes, which is necessary for the functioning of the cell, can take place through ion conduction. For this purpose, the separator element must be wetted with the electrolyte solution and penetrated by it.

A further advantageous development of the rechargeable battery cell according to this disclosure provides that the separator element can be compressed. The compressible separator element can be formed from a fleece, a membrane, a woven fabric, a knitted fabric, an organic material, an inorganic material or a combination thereof. The compressible separator element can, for example, consist of an organic polymer membrane and a nonwoven layer.

In principle, depending on the thickness of the deposited layer of the active metal and the compression properties of the separator element, compressible separator elements of all thicknesses are suitable.

Preferably, however, the thickness of the compressible separator element should not exceed 0.2 mm. However, particularly preferred are smaller thicknesses such as at most 0.15 mm, more preferably at most 0.1 mm, more preferably at most 0.09 mm, more preferably at most 0.08 mm, more preferably at most 0.07 mm, more preferably at most 0.06 mm, more preferably at most 0.05 mm, more preferably at most 0.04 mm, more preferably at most 0.03 mm and very preferably at most 0.02 mm.

In a preferred embodiment, the compressible separator element comprises an organic polymer membrane and at least one nonwoven layer, wherein the organic polymer membrane has a first and a second surface and the nonwoven layer has a first and second nonwoven layer surface. One of the surfaces of the organic polymer membrane is in contact with one of the nonwoven layer surfaces. The separator element can also be a composite of an organic polymer membrane and a nonwoven layer, wherein the organic polymer membrane and the nonwoven layer are so firmly bonded to one another that their contacting surfaces are inseparably connected.

The term “nonwoven layer” within the meaning of this disclosure comprises at least one layer of nonwoven organic or inorganic material. In a preferred embodiment, the nonwoven layer comprises an organic material, namely a polymer, more preferably a polyolefin and very preferably polypropylene or polyethylene. In a further preferred embodiment, the nonwoven layer consists of an inorganic material, preferably a glass fiber fleece.

A further advantageous development of the rechargeable battery cell according to this disclosure provides that the thickness of the nonwoven layer between the first and the second nonwoven layer surface is greater than the thickness of the organic polymer membrane between the first and the second surface, preferably at least twice as great, more preferably at least three times as great, even more preferably at least four times as great and at most at least five times as great.

A further advantageous development of the rechargeable battery cell according to this disclosure provides that the nonwoven layer comprising the polymer additionally comprises a ceramic material, preferably aluminum oxide, silicon oxide or titanium dioxide. In addition to the inorganic material, the nonwoven layer containing the polymer may also comprise an organic binder, e.g., PDVF, PTFE or THV. Both the ceramic material and the binder can be formed as a layer on the surface and/or incorporated into the porous layer structure of the polymer fleece.

A further advantageous development of the rechargeable battery cell according to this disclosure provides that the compressible separator element is formed from a nonwoven layer containing the polymer, which additionally contains a ceramic material.

A further advantageous development of the rechargeable battery cell according to this disclosure provides that the compressible separator element comprises unsubstituted polyolefins (e.g., polypropylene or polyethylene), partially to fully halogen-substituted polyolefins (e.g., partially to fully fluorine-substituted, in particular PVDF, ETFE, PTFE), polyesters, polyamides or polysulfones. Compressible separator elements containing a combination of organic and inorganic materials are, for example, glass fiber fabrics in which the glass fibers are provided with a suitable polymeric coating. The coating preferably contains a fluorine-containing polymer such as polytetrafluoroethylene (PTFE), ethylene tetrafluoroethylene (ETFE), perfluoroethylene propylene (FEP), THV (terpolymer of tetrafluoroethylene, hexafluoroethylene and vinylidene fluoride), a perfluoroalkoxy polymer (PFA), aminosilane, polypropylene or polyethylene (PE).

A further advantageous development of the rechargeable battery cell according to this disclosure provides that one or more separator elements comprise a non-compressible material.

If the battery cell has another space for receiving metallic active metal, which receives the amounts of metallic active metal deposited when the battery cell is being charged, or has other compressible structures, then a further advantageous development of the rechargeable battery cell according to this disclosure provides that all separator elements are made of a non-compressible material.

### Conducting Element

A further advantageous development of the rechargeable battery cell according to this disclosure provides that the compressible structure is formed by at least one conducting element.

The purpose of a conducting element is to facilitate the required electronically conductive connection to the external circuit of the active material of the negative or positive electrode. For this purpose, the conducting element is in contact with the active material involved in the electrode reaction of the negative or positive electrode. The conducting element must consist at least partly of an electronically conductive material. The conducting element is usually made of a metal such as copper, aluminum or nickel.

A further advantageous development of the rechargeable battery cell according to this disclosure provides that the compressible structure is formed by a conducting element which is designed as a composite comprising a plurality of components. A dissipative element can, for example, consist of a compressible structure coated on both sides with a metal such as copper, aluminum or nickel. In addition, the edges or borders of the compressible structure can be coated with metal as well. This creates a compressible conducting element. This compressible conducting element can, for example, be a compressible polymer coated with metal on one or both sides, which is compressed during the deposition of metallic active metal and thus provides space for the deposited metal.

A further advantageous development of the rechargeable battery cell according to this disclosure provides that the compressible structure is formed by a conducting element which consists of a compressible metal. A metal fleece can be used, for example. Optionally, the metal fleece can be coated with another metal.

In one preferred embodiment, the polymer is stable with regard to the SO₂-based electrolyte and with regard to a metal coating, even at higher temperatures. Suitable polymers include, but are not limited to, polypropylene (PP), polyethylene (PE), polyurethane (PU), polystyrene (PS), polyamide (PA), polyethylene terephthalate (PET) or polyvinylidene fluoride (PVDF). The metal coating, which creates electronic conductivity, consists of, for example, copper for the conducting element of the negative electrode and, for example, aluminum for the conducting element of the positive electrode.

In a further advantageous development of the rechargeable battery cell according to this disclosure, the compressible conducting element can be used as a conducting element for the negative electrode, the positive electrode or for both electrodes. If the battery cell consists of a plurality of positive and negative electrodes, individual or all electrodes can contain a compressible conducting element.

The thickness of the compressible conducting element should preferably be no more than 0.1 mm. However, particularly preferred are smaller thicknesses such as at most 0.08 mm, more preferably at most 0.06 mm, more preferably at most 0.04 mm, more preferably at most 0.02 mm and very preferably at most 0.01 mm.

A further advantageous development of the rechargeable battery cell according to this disclosure provides that the thickness of the compressible polymer in the uncompressed state is greater than the thickness of the metal coating, preferably at least twice as great, more preferably at least three times as great, even more preferably at least four times as great and most preferably at least five times as great.

For example, the compressible conducting element can have a metal coating of 1 μm on both sides and a compressible polymer layer of 8 μm between them. In that case, this conducting element has a total thickness of 10 μm.

A further advantageous development of the battery cell according to this disclosure provides that the conducting element of the negative electrode and/or the positive electrode is formed by a non-compressible, planar conducting element in the form of a thin metal sheet or a thin metal foil. The thin metal foil preferably has a perforated or net-like structure. The planar conducting element can also consist of a metal-coated plastic film. These metal coatings have a thickness in the range from 0.1 μm to 20 μm. The active material of the negative or positive electrode is preferably applied to the surface of the thin metal sheet, thin metal film, or metal-coated plastic film. The active material can be applied to the front and/or the back of the planar conducting element. Such planar conducting elements have a thickness in the range from 5 μm to 50 μm. A thickness of the planar conducting element in the range from 10 μm to 30 μm is preferred. When using planar conducting elements, the electrode can have a total thickness of at least 20 μm, preferably at least 40 μm and particularly preferably at least 60 μm. The maximum thickness is at most 200 μm, preferably at most 150 μm and particularly preferably at most 100 μm.

The area-specific capacity of the negative electrode, relative to the coating on one side, is preferably at least 0.5 mAh/cm² when using a planar conducting element in the loaded state, with the following values being more preferred, in this order: 1 mAh/cm², 3 mAh/cm², 5 mAh/cm², 10 mAh/cm², 15 mAh/cm², 20 mAh/cm², 25 mAh/cm².

A further advantageous development of the battery cell according to this disclosure provides that the conducting element of the negative electrode and/or the positive electrode is formed by a three-dimensional conducting element in the form of a porous metal structure, in particular in the form of a metal foam. The term “three-dimensional porous metal structure” refers to any structure made of metal that extends not only over the length and width of the planar electrode, such as the thin metal sheet or metal foil, but also over its thickness dimension. The three-dimensional porous metal structure is so porous that, for example, the active material of the negative electrode, for example, metallic lithium or sodium, can be deposited in the pores of the metal structure or that the active material of the positive electrode can be incorporated into the pores of the metal structure. The amount of active material incorporated or applied is associated with the loading of the electrode.

If the conducting element is three-dimensional in the form of a porous metal structure, in particular in the form of a metal foam, then the respective electrode preferably has a thickness of at least 0.2 mm, more preferably at least 0.3 mm, even more preferably at least 0.4 mm, even more preferably at least 0.5 mm, and at most preferably at least 0.6 mm. In this case, the thickness of the electrodes is significantly greater compared to negative electrodes used in organic metal cells.

One further advantageous embodiment of the rechargeable battery cell according to this disclosure provides that the area-specific capacity of the negative electrode in the loaded state, when using a three-dimensional conducting element, in particular in the form of a metal foam, is preferably at least 2.5 mAh/cm², with the following values being more preferred in this order: 5 mAh/cm², 15 mAh/cm², 25 mAh/cm², 35 mAh/cm², 45 mAh/cm².

A further advantageous embodiment provides that the area-specific capacity of the positive electrode when using a three-dimensional conducting element, in particular in the form of a metal foam, is preferably at least 2.5 mAh/cm², with the following values being more preferred in this order: 5 mAh/cm², 15 mAh/cm², 25 mAh/cm², 35 mAh/cm², 45 mAh/cm², 55 mAh/cm², 65 mAh/cm², 75 mAh/cm². If the conducting element is three-dimensionally and in the form of a porous metal structure, in particular in the form of a metal foam, the amount of active material of the positive electrode, i.e., the loading of the electrode relative to its surface area, is at least 10 mg/cm², preferably at least 20 mg/cm², more preferably at least 40 mg/cm², more preferably at least 60 mg/cm², more preferably at least 80 mg/cm², and particularly preferably at least 100 mg/cm². This loading of the positive electrode has a positive effect on the charging process and the discharging process of the rechargeable battery cell.

### Active Metal

Advantageous developments of the rechargeable battery cell according to this disclosure with regard to the active metal are described below:

In one advantageous development, the rechargeable battery cell, the active metal is
an alkali metal, especially lithium or sodium;
an alkaline earth metal, especially calcium;
a metal from group 12 of the periodic table, in particular zinc; or
aluminum.

One advantageous development of the rechargeable battery cell according to this disclosure provides that the active metal is lithium or sodium.

A further advantageous development of the rechargeable battery cell according to this disclosure provides that the active metal is lithium.

### Negative Electrode

The active material of the negative electrode is the active metal in metallic form. This material is deposited on the conducting element of the negative electrode when the rechargeable battery cell is charged. This means that the negative electrode contains not only the metallic active metal as the active material but also a conducting element. In one advantageous development of the rechargeable battery cell, the active material of the negative electrode is an alkali metal, in particular lithium or sodium.

One advantageous development of the rechargeable battery cell according to this disclosure provides that, at least during the first charging process, a first part of the metallic active metal is deposited with a current that is higher than the current with which the remaining part of the metallic active metal is deposited. This measure has the considerable advantage that the metallic active metal is deposited uniformly during the charging process and not in the form of dendrites. Thus, the uncontrollable dendrite growth, which leads to an accumulation of a highly reactive metal with a large surface area, is significantly minimized in the battery cell according to this disclosure.

A further advantageous development of the rechargeable battery cell according to this disclosure provides that the first part of the metallic active metal which is deposited during the first charging process with a higher current is at least 3% by weight, preferably at least 5% by weight, more preferably at least 10% by weight, more preferably at least 30% by weight, more preferably at least 50% by weight, more preferably at least 70% by weight, more preferably at least 90% by weight and particularly preferably at least 100% by weight based on the total amount of the deposited active metal.

One advantageous development of the rechargeable battery cell according to this disclosure provides that the active material of the battery cell is metallic lithium and that at least during the first charging process, a part of the metallic lithium is deposited with a current of at least 3 mA/cm², preferably at least 3.5 mA/cm², preferably of at least 4.0 mA/cm², more preferably of at least 4.5 mA/cm², more preferably of at least 5.0 mA/cm², more preferably of at least 5.5 mA/cm² and particularly preferably of at least 6.0 mA/cm² based on the one-sided surface of the negative electrode. As already described above, this measure has the considerable advantage that the metallic lithium is deposited uniformly during the charging process and not in the form of dendrites. Thus, the uncontrollable lithium dendrite growth, which leads to an accumulation of a highly reactive metal with a large surface area, is significantly minimized in the battery cell according to this disclosure.

A further advantageous development of the rechargeable battery cell according to this disclosure provides that the part of the metallic lithium that is deposited during the first charging process with a current of at least 3 mA/cm² based on the one-sided surface of the negative electrode is at least 3% by weight, preferably at least 5% by weight, more preferably at least 10% by weight, even more preferably at least 30% by weight, even more preferably at least 50% by weight, more preferably at least 70% by weight, even more preferably at least 90% by weight and most preferably at least 100% by weight based on the total amount of lithium deposited.

Advantageous developments of the rechargeable battery cell according to this disclosure with regard to the negative electrode are described below:

One advantageous development of the rechargeable battery cell according to this disclosure provides that the electronically conductive conducting element of the negative electrode is free of metallic active metal in the discharged state of the rechargeable battery cell. When the battery cell is charged, metallic active metal is deposited on the electronically conductive conducting element of the negative electrode. During the discharge, the metallic active metal is essentially completely dissolved and enters the host matrix of the active material of the positive electrode in the form of ions.

A further advantageous development of the battery cell according to this disclosure provides that the electronically conductive conducting element of the negative electrode comprises metallic active metal even before the rechargeable battery cell is charged for the first time. When the battery cell is charged, additional metallic active metal is deposited on the electronically conductive conducting element. During the discharge, the metallic active metal is completely or partially dissolved and enters the host matrix of the active material of the positive electrode in the form of ions. The metallic active metal, which is already on the conducting element, can be applied to the conducting element before the battery cell is assembled and installed together with it into the battery cell. On the other hand, the metallic active metal can be deposited on the conducting element of the negative electrode by a preceding initialization charging process prior to the operation of the battery cell, i.e., prior to the first charging and discharging process.

A further advantageous development of the battery cell according to this disclosure provides that the conducting element of the negative electrode is at least partially formed from a material which can store the active metal. In such a further development, a part of the active metal resulting from the electrode reaction is initially stored in the electronically conductive conducting element made of the material which can store the active metal when the battery cell is charged. As the battery cell continues to be charged, metallic active metal is deposited on the electronically conductive conducting element. During the discharge, the metallic active metal is completely or partially dissolved and enters the host matrix of the active material of the positive electrode in the form of ions.

A further advantageous development of the battery cell according to this disclosure provides that the conducting element of the negative electrode is at least partially formed from a lithium-storing material. The lithium-storing material can, for example, be the insertion material carbon, particularly in the graphite modification. It can also be a material that forms an alloy with lithium, such as lithium-storing metals and metal alloys (e.g., Si, Ge, Sn, SnCoₓC_{y}, SnSiₓ and the like, preferably silicon) or oxides of lithium-storing metals and metal alloys (e.g., SnOₓ, SiOₓ, oxide glasses of Sn, Si and the like) or a lithium intercalation material that does not contain carbon, such as lithium titanates, in particular Li₄Ti₅O₁₂. Conversion materials such as transition metal oxides can be used as lithium-storing materials as well.

A further advantageous development of the battery cell according to this disclosure provides that the conducting element of the negative electrode is at least partially formed from a sodium-storing material. The sodium-storing material can, for example, be the insertion material carbon, in particular hard carbon, soft carbon, graphene or heteroatom-doped carbons. It can also be a material that forms alloys with sodium, such as sodium-storing metals and metal alloys (e.g., Sn, Sb), sulfides or oxides of sodium-storing metals and metal alloys (e.g., SnSₓ, SbSₓ, oxide glasses of Sn, Sb and the like). It can also be a lithium intercalation material which does not contain carbon, such as sodium titanates, in particular Na₂Ti₃O₇ or NaTi₂ (PO₄)₃. Conversion materials such as transition metal oxides also be used as sodium-storing materials as well.

### Electrolyte

Advantageous developments of the rechargeable battery cell are described below with regard to the SO₂-based electrolyte.

As described above, the SO₂-based electrolyte used in the rechargeable battery cell according to this disclosure contains SO₂ not only as an additive at a low concentration, but also at concentrations at which the mobility of the ions of the first conductive salt, which is contained in the electrolyte and effects the charge transport, is at least partially, largely or even fully ensured by the SO₂.

Compared to rechargeable battery cells with electrolytes known from prior art, a rechargeable battery cell with such an electrolyte has the advantage that the first conductive salt contained therein has higher oxidation stability and consequently exhibits essentially no decomposition at higher cell voltages. This electrolyte is oxidation-stable, preferably at least up to an upper potential of 4.0 volts, more preferably at least up to an upper potential of 4.2 volts, more preferably at least up to an upper potential of 4.4 volts, more preferably at least up to an upper potential of 4.6 volts, more preferably at least to an upper potential of 4.8 volts, and particularly preferably at least to an upper potential of 5.0 volts. Thus, when such an electrolyte is used in a rechargeable battery cell, there is little or no electrolyte decomposition within the working potentials, i.e., in the range between the end-of-charge voltage and the end-of-discharge voltage of both electrodes of the rechargeable battery cell. This allows rechargeable battery cells according to this disclosure to have an end-of-charge voltage of at least 4.0 volts, more preferably at least 4.4 volts, more preferably at least 4.8 volts, more preferably at least 5.2 volts, more preferably at least 5.6 volts and particularly preferably of at least 6.0 volts.

The service life of the rechargeable battery cell containing this electrolyte is significantly longer than rechargeable battery cells containing electrolytes known from prior art.

Furthermore, a rechargeable battery cell having such an electrolyte is resistant to low temperatures as well. For example, at a temperature of −40°° C., 61% of the charged capacity can still be discharged. The conductivity of the electrolyte at low temperatures is sufficient for operating a battery cell.

Furthermore, a rechargeable cell with such an electrolyte has increased stability with regard to residual amounts of water. If there are still small residual amounts of water in the electrolyte (in the ppm range), then the electrolyte or the first conductive salt forms hydrolysis products with the water which are clearly less aggressive towards the cell components in comparison to the SO₂-based electrolytes known from prior art. Because of this, the absence of water in the electrolyte plays a less important role in comparison to the SO₂-based electrolytes known from prior art. These advantages of the electrolyte according to this disclosure outweigh the disadvantage that arises from the fact that the first conductive salt according to formula (I) has a significantly larger anion size compared to the conductive salts known from prior art. This higher anion size leads to a lower conductivity of the first conductive salt according to formula (I) compared to the conductivity of, for example, LiAlCl₄ or NaAlCl₄.

In a further advantageous embodiment of the rechargeable battery cell, the substituents R¹, R², R³, and R⁴ of the first conductive salt are selected independently from the group consisting of:
C₁-C₆ alkyl, preferably C₂-C₄ alkyl, particularly preferably 2-propyl, methyl and ethyl;
C₂-C₄ alkenyl, preferably C₂-C₄ alkenyl, particularly preferably ethenyl and propenyl;
C₂-C₄ alkynyl; preferably C₂-C₄ alkynyl;
C₃-C₄ cycloalkyl;
phenyl; and
C₅-C₇ heteroaryl;
wherein the aliphatic, cyclic, aromatic and heteroaromatic groups may be unsubstituted or substituted.

In a further advantageous development of the rechargeable battery cell according to this disclosure, at least two of the substituents R¹, R², R³, and R⁴ are bridged with one another to form a bidentate chelate ligand. Such a bidentate chelate ligand can have the following structure, for example:

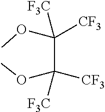 [SMILES: COC(C(F)(F)F)(C(F)(F)F)C(OC)(C(F)(F)F)C(F)(F)F]

Preferably, three or even four of the substituents R¹, R², R³, and R⁴ can also be bridged with one another to form a tridentate or tetradentate chelate ligand. The chelate ligand coordinates to the central atom Z to form a chelate complex. The term “chelate complex”—also referred to as chelate for short—stands for complex compounds in which a multidentate ligand (has more than one free electron pair) occupies at least two coordination sites (bonding sites) of the central atom. The central atom is the positively charged metal ion Al³⁺ or B³⁺. Ligands and central atom are linked via coordinate bonds, which means that the bonding pair of electrons is provided solely by the ligand.

In order to improve the solubility of the first conductive salt in the SO₂-based electrolyte, in a further advantageous embodiment of the rechargeable battery cell the substituents R¹, R², R³ and R⁴ are substituted by at least one fluorine atom and/or by at least one chemical group, where the chemical group is selected from the group consisting of C₁-C₄ alkyl, C₂-C₄ alkenyl, C₂-C₄ alkynyl, phenyl and benzyl. The chemical groups C₁-C₄ alkyl, C₂-C₄ alkenyl, C₂-C₄ alkynyl, phenyl and benzyl have the same properties or chemical structures as the hydrocarbon groups described above. In this context, substituted means that individual atoms or groups of atoms of the substituents R¹, R², R³ and R⁴ are replaced by the fluorine atom and/or by the chemical group.

A particularly high solubility of the first conductive salt in the SO₂-based electrolyte can be achieved if at least one of the substituents R¹, R², R³ and R⁴ is a CF₃ group or an OSO₂CF₃ group.

In one further advantageous embodiment of the rechargeable battery cell, the first conductive salt is selected from the group consisting of:

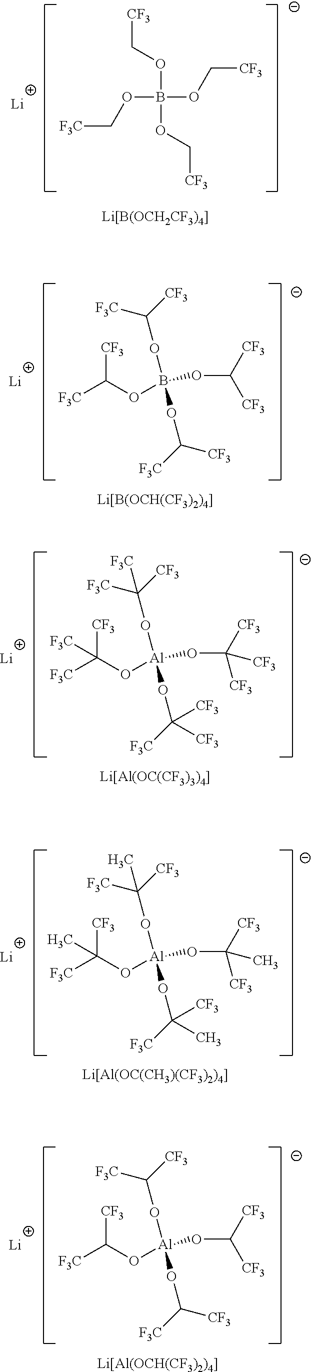

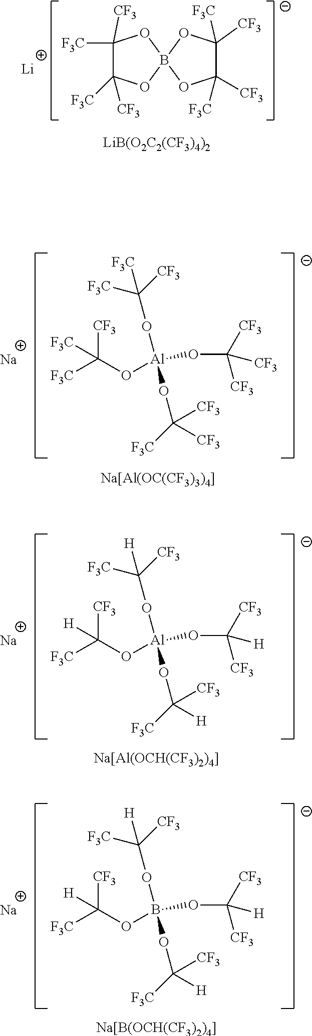

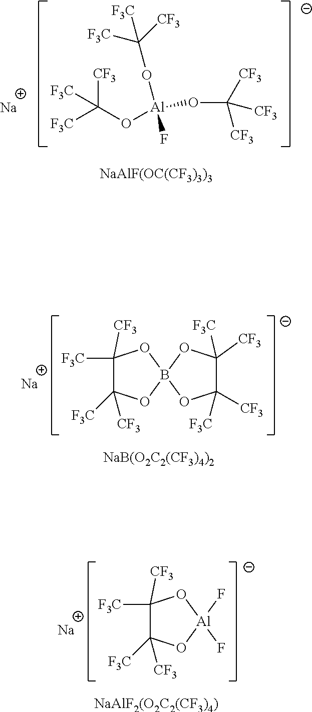

In a further advantageous embodiment of the rechargeable battery cell according to this disclosure, the electrolyte has at least one second conductive salt which differs from the first conductive salt according to formula (I), in order to adjust the conductivity and/or other properties of the electrolyte to a desired value. This means that, in addition to the first conductive salt, the electrolyte can contain one or further second conductive salts which differ from the first conductive salt in terms of their chemical composition and their chemical structure.

In one further advantageous embodiment of the rechargeable battery cell according to this disclosure, the second conductive salt is an alkali metal compound, in particular, a lithium compound or a sodium compound. The alkali metal compound or the lithium compound or the sodium compound is selected from the group consisting of an aluminate, a halide, an oxalate, a borate, a phosphate, an arsenate and a gallate. Preferably, the second conducting salt is a lithium or sodium tetrahalogenoaluminate, in particular, LiAlCl₄ or NaAlCl₄.

Furthermore, in a further advantageous embodiment of the rechargeable battery cell according to this disclosure, the electrolyte contains at least one additive. This additive is preferably selected from the group consisting of vinylene carbonate and its derivatives, vinyl ethylene carbonate and its derivatives, methyl ethylene carbonate and its derivatives, lithium (bisoxalato) borate, lithium difluoro (oxalato) borate, lithium tetrafluoro (oxalato) phosphate, lithium oxalate, 2-vinylpyridine, 4-vinylpyridine, cyclic exomethylene carbonates, sultones, cyclic and acyclic sulfonates, acyclic sulfites, cyclic and acyclic sulfinates, organic esters of inorganic acids, acyclic and cyclic alkanes, said acyclic and cyclic alkanes having a boiling point of at least 36° C. at 1 bar, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocyclics.

Based on the total weight of the electrolyte composition, the electrolyte has the following composition in a further advantageous development of the rechargeable battery cell:
(i) 5 to 99.4 wt % sulfur dioxide,
(ii) 0.6 to 95 wt % of the first conductive salt,
(iii) 0 to 25 wt % of the second conductive salt and
(iv) 0 to 10 wt % of the additive.

As already mentioned above, the electrolyte can contain not only a first conductive salt according to formula (I) and a second conductive salt, but also a plurality of first conductive salts according to formula (I) and a plurality of second conductive salts. In the latter case, the aforementioned percentages also include a plurality of first conductive salts and a plurality of second conductive salts. The molar concentration of the first conductive salt is in the range of 0.01 mol/L to 10 mol/L, preferably 0.05 mol/L to 10 mol/L, more preferably 0.1 mol/L to 6 mol/L, and particularly preferably 0.2 mol/L to 3.5 mol/L based on the total volume of the electrolyte.

A further advantageous development of the rechargeable battery cell according to this disclosure provides that the electrolyte contains at least 0.1 mole of SO₂, preferably at least 1 mole of SO₂, more preferably at least 5 moles of SO₂, more preferably at least 10 moles of SO₂ and particularly preferably at least 20 moles of SO₂ per mole of conductive salt. The electrolyte can also contain very high molar proportions of SO₂, the preferred upper limit being 2600 moles SO₂ per mole of conductive salt, and upper limits of 1500, 1000, 500 and 100 moles SO₂ per mole of conductive salt in this order being more preferred. The term “per mole of conductive salt” refers to all conductive salts contained in the electrolyte. SO₂-based electrolytes having such a concentration ratio between SO₂ and the conductive salt have the advantage that they can dissolve a larger amount of conductive salt compared to the electrolytes known from prior art which are based, for example, on an organic solvent mixture. Within the scope of this disclosure, it was found that, surprisingly, an electrolyte with a relatively low concentration of conductive salt is advantageous despite the associated higher vapor pressure, in particular with regard to its stability over many charging and discharging cycles of the rechargeable battery cell. The concentration of SO₂ in the electrolyte affects its conductivity. Thus, by choosing the SO₂ concentration, the conductivity of the electrolyte can be adapted to the planned use of a rechargeable battery cell operated with this electrolyte.

The total content of SO₂ and the first conductive salt can be greater than 50 weight percent (wt %) of the weight of the electrolyte, preferably greater than 60 wt %, more preferably greater than 70 wt %, more preferably greater than 80 wt %, more preferably greater than 85 wt %, more preferably greater than 90 wt %, more preferably greater than 95 wt % or more preferably greater than 99 wt %.

The electrolyte can contain at least 5 wt % SO₂ relative to the total amount of the electrolyte contained in the rechargeable battery cell, values of 20 wt % SO₂, 40 wt % SO₂ and 60 wt % SO₂ being more preferred. The electrolyte can also contain up to 95 wt % SO₂, with maximum values of 80 wt % SO₂ and 90 wt % SO₂, in this order, being preferred.

It is within the scope of this disclosure that the electrolyte preferably has only a small percentage or even no percentage of at least one organic solvent. The proportion of organic solvents in the electrolyte present in the form of, for example, one or a mixture of a plurality of solvents, may preferably be at most 50 wt % of the weight of the electrolyte. Lower proportions of at most 40 wt %, at most 30 wt %, at most 20 wt %, at most 15 wt %, at most 10 wt %, at most 5 wt % or at most 1 wt % of the weight of the electrolyte are particularly preferred. More preferably, the electrolyte is free of organic solvents. Due to the low proportion of organic solvents or even their complete absence, the electrolyte is either hardly flammable or not at. This increases the operational safety of a rechargeable battery cell operated with such an SO₂-based electrolyte. More preferably, the SO₂-based electrolyte is substantially free of organic solvents.

Based on the total weight of the electrolyte composition, the electrolyte has the following composition in a further advantageous development of the rechargeable battery cell:
(i) 5 to 99.4 wt % sulfur dioxide,
(ii) 0.6 to 95 wt % of the first conductive salt,
(iii) 0 to 25 wt % of the second conductive salt,
(iv) 0 to 10 wt % of the additive and
(v) 0 to 50 wt % of an organic solvent.

### Positive Electrode

Advantageous developments of the rechargeable battery cell according to this disclosure with regard to the positive electrode are described below:

A first advantageous development of the rechargeable battery cell according to this disclosure provides that the positive electrode can be charged at least up to an upper potential of 4.0 volts, preferably up to a potential of 4.4 volts, more preferably at least up to a potential of 4.8 volts, even more preferably at least up to a potential of 5.2 volts, even more preferably at least up to a potential of 5.6 volts and most preferably at least up to a potential of 6.0 volts.

In a further advantageous development of the rechargeable battery cell according to this disclosure, the positive electrode contains at least one active material. This active material can store ions of the active metal and during operation of the battery cell can release and take up the ions of the active metal again.

In one further advantageous development of the rechargeable battery cell according to this disclosure, the positive electrode contains at least one intercalation compound. In the context of this disclosure, the term “intercalation compound” is to be understood as meaning a subcategory of the insertion materials described above. This intercalation compound acts as a host matrix that has interconnected vacancies. The ions of the active metal can diffuse into these vacancies during the discharge process of the rechargeable battery cell and can be intercalated there. Little or no structural changes occur in the host matrix as a result of this intercalation of the active metal ions.

In a further advantageous development of the rechargeable battery cell according to this disclosure, the positive electrode contains at least one conversion compound as an active material. As used herein, the term “conversion compounds” refers to materials that form other materials during electrochemical activity; i.e., chemical bonds are broken and re-formed during the charging and discharging of the battery cell. Structural changes occur in the matrix of the conversion compound during the uptake or release of the active metal ions.

In a further advantageous development of the rechargeable battery cell according to this disclosure, the active material has the composition AₓM′_{y}M″_{z}Oₐ. In this composition AₓM′_{y}M″_{z}Oₐ,
A is at least one metal selected from the group consisting of the alkali metals, the alkaline earth metals, the metals of group 12 of the periodic table, or aluminum,
M′is at least one metal selected from the group consisting of the elements Ti, V, Cr, Mn, Fe, Co, Ni, Cu and Zn;
M″ is at least one element selected from the group consisting of the elements of groups 2, 3, 4, 5, 6, 7, 8, 9, 10, 11, 12, 13, 14, 15 and 16 the periodic table of the elements;
x and y are, independently of one another, numbers greater than 0;
z is a number greater than or equal to 0; and
a is a number greater than 0.

A is preferably the metal lithium or sodium, i.e., the compound may have the composition LiₓM′_{y}M″_{z}Oₐ or NaₓM′_{y}M″_{z}Oₐ.

The indices y and z in the composition AₓM′_{y}M″_{z}Oₐ refer to all of the metals and elements represented by M′ or M″. For example, if M′ comprises two metals M′¹ and M′², then the following applies for the index y: y=y1+y2, wherein y1 and y2 represent the indices of the metals M′¹ and M′². The indices x, y, z and a must be chosen in such a way that there is charge neutrality within the composition. Examples of compounds in which M′ comprises two metals are lithium nickel manganese cobalt oxides of the composition LiₓNi_{y1}Mn_{y2}Co_{z}O₂ where M′¹=Ni, M′²=Mn and M″=Co. Examples of compounds in which z=0, that is to say which have no further metal or element M″, are the lithium cobalt oxides LiₓCo_{y}Oₐ. For example, if M″ comprises two elements, for example, a metal M″¹ and phosphorus as M″², then the following applies for the index z: z=z1+z2, wherein z1 and z2 are the indices of the metal M″¹ and of phosphorus (M″²). The indices x, y, z and a must be chosen in such a way that there is charge neutrality within the composition. Examples of compounds in which A comprises lithium, M″ comprises a metal M″¹ and phosphorus as M″² are lithium iron manganese phosphates LiₓFe_{y}Mn_{z1}P_{z2}O₄ where A=Li, M′=Fe, M″¹=Mn and M″²=P, and z2=1. In another composition, M″ may comprise two non-metals, for example, fluorine as M″¹ and sulfur as M″². Examples of such compounds are lithium iron fluorosulfates Fe_{y}F_{z1}S_{z2}O₄ with A=Li, M′=Fe, M″₁=F and M″₂=P.

A further advantageous development of the rechargeable battery cell according to this disclosure provides that M′ consists of the metals nickel and manganese and M″ is cobalt. This can include compositions of the formula LiₓNi_{y1}Mn_{y2}Co_{z}O₂ or the formula NaₓNi_{y1}Mn_{y2}Co_{z}O₂ (NMC), i.e., lithium or sodium nickel manganese cobalt oxides which have the structure of layered oxides. Examples of these lithium nickel manganese cobalt oxide active materials are LiNi_{1/3}Mn_{1/3}Co_{1/3}O₂ (NMC111), LiNi_{0.6}Mn_{0.2}Co_{0.2}O₂ (NMC622) and LiNi_{0.8}Mn_{0.1}Co_{0.1}O₂ (NMC811). Examples of these sodium nickel manganese cobalt oxide active materials are Na[Ni_{1/3}Mn_{1/3}Co_{1/3}]O₂ and Na_{0.6}[Ni_{0.25}Mn_{0.5}Co_{0.25}]O₂. With these compounds, positive electrodes for rechargeable battery cells having a cell voltage of over 4.6 volts can be produced.

A further advantageous development of the rechargeable battery cell according to this disclosure provides that the active material is rich in lithium and manganese (lithium- and manganese-rich oxide material). This metal oxide can have the composition LiₓMn_{y}M″_{z}Oₐ. M′ thus represents the metal manganese (Mn) in the formula LiₓMn′_{y}M″_{z}Oₐ described above. The index x is greater than or equal to 1 in this regard; the index y is greater than the index z or greater than the sum of the indices z1+z2+z3, etc. For example, if M″ comprises two metals M″¹ and M″² having the indices z1 and z2 (for example, Li_{1.2}Ni_{0.525}Mn_{0.175}Co_{0.1}O₂, where M″¹=Ni z1=0.175 and M″²=Co z2=0.1) then the following applies for the index y: y>z1+z2. The index z is greater than or equal to 0 and the index a is greater than 0. The indices x, y, z and a must be chosen in such a way that there is charge neutrality within the composition. Metal oxides rich in lithium and manganese can also be described by the formula mLi₂MnO₃·(1−m)LiM′O₂ where 0<m<1. Examples of such compounds are Li_{1.2}Mn_{0.525}Ni_{0.175}Co_{0.1}O₂, Li_{1.2}Mn_{0.6}Ni_{0.2}O₂ or Li_{1.2}Ni_{0.13}Co_{0.13}Mn_{0.54}O₂.

A further advantageous development of the rechargeable battery cell according to this disclosure provides that the composition has the formula AₓM′_{y}M″_{z}O₄. These compounds are spinel structures. For example, A can be lithium or sodium, M′ can be cobalt, and M″ can be manganese. In this case, the active material is lithium cobalt manganese oxide (LiCoMnO₄) or sodium cobalt manganese oxide (NaCoMnO₄). LiCoMnO₄ or NaCoMnO₄ can be used to produce positive electrodes for rechargeable battery cells having a cell voltage of over 4.6 volts. In another example, M′ may be nickel and M″ may be manganese. In this case, the active material is lithium or sodium nickel manganese oxide, for example, LiNiMnO₄. The molar proportions of the two metals M′ and M″ may vary. For example, lithium nickel manganese oxide may have the composition LiNi_{0.5}Mn_{1.5}O₄.

In a further advantageous development of the rechargeable battery cell according to this disclosure, the positive electrode contains, as the active material, at least one active material representing a conversion compound. Conversion compounds undergo a solid-state redox reaction during the uptake of the active metal, for example, lithium or sodium, the crystal structure of the material changing during the reaction. This occurs while chemical bonds are breaking and recombining. Completely reversible reactions of conversion compounds may include the following, for example:

Type A: MX_{z}↔+y Li M+z Li_{(y/z)}X

### Type B: X↔+y Li Li_{y}X

Examples of conversion compounds are FeF₂, FcF₃, CoF₂, CuF₂, NiF₂, BiF₃, FeCl₃, FeCl₂, CoCl₂, NiCl₂, CuCl₂, AgCl, LiCl, S, Li₂S, Se, Li₂Se, Te, I and LiI.

In a further advantageous embodiment, the compound has the composition AₓM′_{y}M″¹_{z1}M″²_{z2}O₄, where M″¹ is selected from the group formed by the elements of groups 2, 3, 4, 5, 6, 7, 8, 9, 10, 11, 12, 13, 14, 15, and 16 of the periodic table of the elements, M″² is the element phosphorus, x and y are independently numbers greater than 0, z1 is a number greater than 0, and z2 has the value 1. The compound with the composition AₓM′_{y}M″¹_{z1}M″²_{z2}O₄ is a so-called lithium or sodium metal phosphate, for example. In particular, these compounds have the compositions LiₓFe_{y}Mn_{z1}P_{z2}O₄, LiFePO₄, NaₓFe_{y}Mn_{z1}P_{z2}O₄ or NaFePO₄. Lithium or sodium metal phosphates of other compositions can also be used for the battery cell according to this disclosure.

In a further advantageous development of the rechargeable battery cell according to this disclosure, the active material has the composition NaₓM′_{y}[Fe(CN)₆]ₐ·nH₂O, with M′ being at least one metal selected from the group consisting of the elements Ti, V, Cr, Mn, Fc, Co, Ni, Cu and Zn. M′ can be two or more metals M′¹, M′², M′³ etc. In that case, the following applies for the index y: y=y1+y2, wherein y1 and y2 are the indices of the metals M′¹ and M′², with n being a number greater than or equal to zero, and x, all indices y (y, y1, y2 etc.) and a being numbers that are independently greater than 0. This type of compound is hexacyanoferrate, also known as “Prussian blue” and “Prussian white.” Examples of such compounds are Na₂NiFe(CN)₆, FeFe(CN)₆·4H₂O, Na_{0.61}FeFe(CN)₆, Na_{1.89}Mn[Fe(CN)₆]_{0.97} and NaN_{0.3}Mn_{0.7}Fe(CN)₆.

A further advantageous development of the rechargeable battery cell according to this disclosure provides that the positive electrode contains at least one metal compound. This metal compound is selected from the group consisting of a metal oxide, a metal halide and a metal phosphate. The metal of this metal compound is preferably a transition metal with atomic numbers 22 to 28 in the periodic table of the elements, in particular cobalt, nickel, manganese or iron.

A further advantageous development of the rechargeable battery cell according to this disclosure provides that the positive electrode contains at least one metal compound which has the chemical structure of a spinel, a layered oxide, a conversion compound or a polyanionic compound.

It is within the scope of this disclosure that the positive electrode contains at least one of the described compounds or a combination of the compounds as active material. A combination of the compounds refers to a positive electrode which contains at least two of the materials described.

### Binding Agent

A further advantageous development of the battery cell according to this disclosure provides that the conducting element of the negative electrode and/or the positive electrode has at least one binding agent.

This binding agent is preferably a fluorinated binding agent, in particular a polyvinylidene fluoride and/or a terpolymer formed from tetrafluoroethylene, hexafluoropropylene, and vinylidene fluoride. However, it can also be a binding agent consisting of a polymer that is constructed from monomeric structural units of a conjugated carboxylic acid or from the alkali metal, alkaline earth metal, or ammonium salt of this conjugated carboxylic acid or from a combination thereof. Furthermore, the binding agent can also comprise a polymer based on monomeric styrene and butadiene structural units. In addition, the binding agent can also be a binding agent from the group of carboxymethyl celluloses. The binding agent is found in the negative electrode preferably in a concentration of at most 20 wt %, more preferably at most 15 wt %, more preferably at most 10 wt %, more preferably at most 7 wt %, more preferably at most 5 wt %, and particularly preferably at most 2 wt % based on the total weight of the negative electrode.

### Structure of the Rechargeable Battery Cell

Advantageous developments of the rechargeable battery cell according to this disclosure are described below with regard to its structure:

In order to further improve the function of the rechargeable battery cell, a further advantageous development of the rechargeable battery cell according to this disclosure provides that the rechargeable battery cell includes a plurality of negative electrodes and a plurality of positive electrodes which are arranged in the housing in an alternating stack. This could, for example, be a prismatic housing. In this case, the positive electrodes and the negative electrodes are preferably each electrically separated from one another by separator elements. The separator element can also be folded in the housing of the rechargeable battery cell, for example, in the form of a so-called “Z-Folding.” With this Z-Folding, a strip-shaped separator element is folded in a Z-like manner through or around the electrodes. Furthermore, the separator element can also be designed as separator paper.

However, the rechargeable battery cell can also be designed as a wound cell in which the electrodes consist of thin layers that are wound up together with a separator element. A round housing can be used in this regard.

It is also within the scope of this disclosure for the separator element to be in the form of an enclosure, with each positive electrode or each negative electrode being enclosed by the enclosure.

Each of the described rechargeable battery cells may contain one or a plurality of compressible separator elements and/or one or a plurality of separator elements made of a non-compressible material, as outlined in detail in the description.

Further advantageous properties of this disclosure are described and explained in more detail below using figures, examples and experiments.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows a first embodiment of a rechargeable battery cell according to this disclosure in a cross-sectional view;

FIG. 2a+b show a schematic detailed representation of the compressible conducting element 27 and the compressible separator element 21 of the first embodiment of FIG. 1;

FIG. 3 shows a second embodiment of a rechargeable battery cell according to this disclosure in an exploded view;

FIG. 4 shows a third embodiment of the rechargeable battery cell according to this disclosure in an exploded view;

FIG. 5 shows the course of the charging current, the voltage and the temperature over time during the first charging cycle of a full cell containing metallic lithium as the active material of the negative electrode and whose electrodes were separated by a non-compressible separator element;

FIG. 6 shows a picture of the full cell used in FIG. 5, where the housing was damaged by a crack during the charging of the full cell;

FIG. 7a shows schematically an uncharged battery cell with a conducting element, a compressible separator element consisting of a polymer membrane and a non-woven polymer and a cathode. There is no lithium on the conducting element; the separator element is in an uncompressed state;

FIG. 7b shows schematically a charged battery cell with a conducting element, a compressible separator element consisting of a polymer membrane and a non-woven polymer and a cathode. There is lithium on the conducting element; the separator element is in a compressed state;

FIG. 8 shows the charge capacity in Ah and the cycle efficiency in % as a function of the number of cycles of a full cell containing metallic lithium as the active material of the negative electrode and whose electrodes were separated by a compressible separator element;

FIG. 9 shows the conductivities in [mS/cm] of electrolytes 1, 4, and 6 from Example 1 as a function of the concentration of compounds 1, 4, and 6; and

FIG. 10 shows the conductivities in [mS/cm] of the electrolytes 3 and 5 from example 1 as a function of the concentration of the compounds 3 and 5.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

It shall be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “positive electrode,” “negative electrode,” “conductive salt,” and “binder,” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

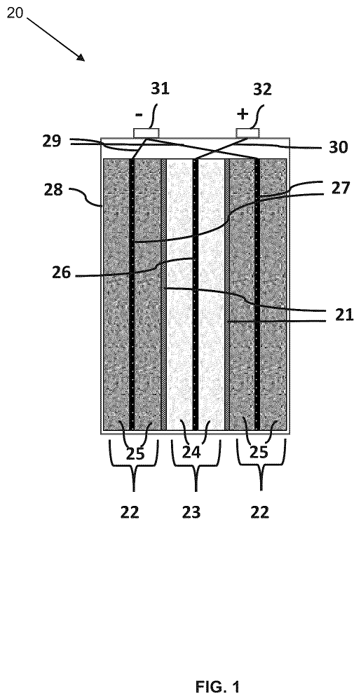

FIG. 1 shows a cross-sectional view of a first embodiment of a rechargeable battery cell 20 according to this disclosure. This rechargeable battery cell 20 is designed as a prismatic cell and has a housing 28, inter alia. This housing 28 encloses an electrode arrangement which comprises a positive electrode 23 and two negative electrodes 22. The positive electrode 23 and the negative electrodes 22 are arranged in an alternately stacked manner in the electrode arrangement. However, the housing 28 can also accommodate more positive electrodes 23 and/or negative electrodes 22. It is generally preferred for the number of negative electrodes 22 to be greater by one than the number of positive electrodes 23. As a result, the outer end faces of the electrode stack are formed by the electrode surfaces of the negative electrodes 22. The electrodes 22, 23 are connected to corresponding connection contacts 31, 32 of the rechargeable battery cell 20 via electrode connections 29, 30. The rechargeable battery cell 20 is filled with an SO₂-based electrolyte in such a way that the electrolyte penetrates as completely as possible into all the pores or cavities. The electrolyte is not visible in FIG. 1. The housing 28 of the rechargeable battery cell 20 is essentially cuboid, with the electrodes 22, 23 and the walls of the housing 28 shown in a sectional view extending perpendicular to the plane of the drawing and being shaped essentially straight and flat. In the present embodiment, the positive electrode 23 contains an intercalation compound as active material. This intercalation compound is NMC811.

In the present embodiment, the electrodes 22, 23 are embodied flat, i.e., as layers with a smaller thickness in relation to the extension of their surface. They are separated from each other by compressible separator elements 21. The positive electrode 23 has a conducting element 26 in the form of a planar metal film to which the active material 24 of the positive electrode 23 is applied on both sides. In the present embodiment, the negative electrodes 22 each comprise a compressible conducting element 27, onto which the active material 25 of the negative electrode 22 is deposited on both sides during the charging process. Alternatively, the deposition can be carried out on the compressible conducting elements of the edge electrodes, i.e., the electrodes that close the electrode stack, on one side only. The non-coated side faces the wall of the housing 28.

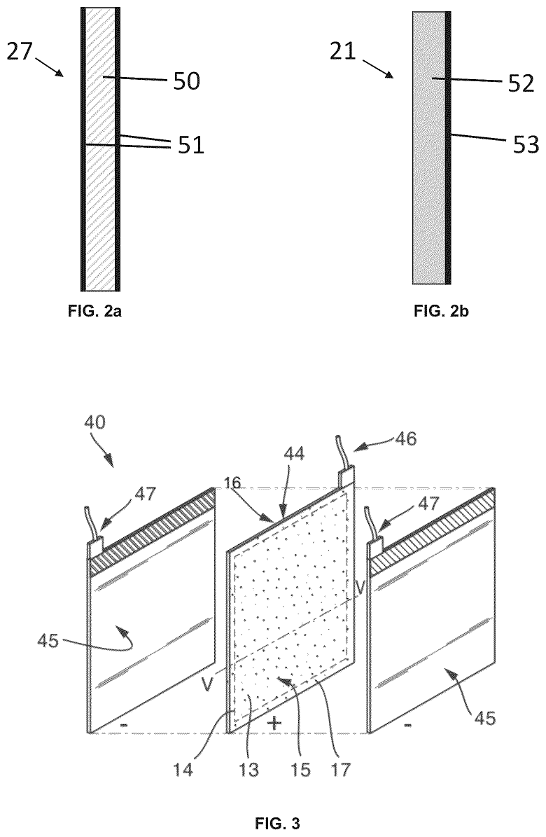

FIG. 2a shows a cross-sectional view of the compressible conducting element 27 of the negative electrode from FIG. 1. The compressible conducting element 27 consists of a compressible structure 50 and metal coatings 51 on both sides of the compressible structure 50. In the present embodiment, the compressible structure comprises a polypropylene film with metal coatings made of copper.

FIG. 2b shows a cross-sectional view of the compressible separator element 21 from FIG. 1. The compressible separator element consists of a compressible structure 52 and a polymer membrane 53 on one side of the compressible structure 52. The compressible structure 52 and the polymer membrane 53 can be firmly connected to one another or each form a separate unit. In the present embodiment, the compressible structure comprises a non-woven polymer fleece which is connected to a polymer membrane made of polypropylene.

FIG. 3 shows a second embodiment of one rechargeable battery cell 40 according to this disclosure in an exploded view. This second embodiment is distinguished from the embodiments explained above in that the positive electrode 44 is enclosed by an enclosure 13 made from a compressible separator element 21. In this case, a surface area extent of the enclosure 13 is greater than a surface area extent of the positive electrode 44, the boundary 14 of which is drawn in as a dashed line in FIG. 3. Two layers 15, 16 of the enclosure 13, which cover the positive electrode 44 on both sides, are connected to one another by an edge connection 17 at the peripheral edge of the positive electrode 44. The two negative electrodes 45 are not enclosed. The electrodes 44 and 45 can be contacted via the electrode connections 46 and 47.

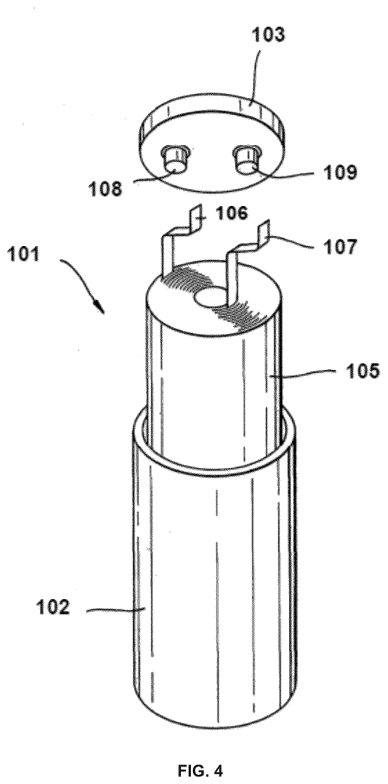

FIG. 4 shows a third embodiment of a rechargeable battery cell 101 according to this disclosure in an exploded view. The essential structural elements of a battery cell 101 with a wound electrode arrangement are shown. In a cylindrical housing 102 with a cover part 103, there is an electrode arrangement 105 which is wound from a web-like starting material. The web consists of a plurality of layers including a positive electrode, a negative electrode, and a separator element running between the electrodes, which electrically mechanically insulates the electrodes from one another but is sufficiently porous or ionically conductive to allow the necessary ion exchange. This way, large electrochemically active surfaces are created which enable a correspondingly high current yield. The positive electrode has a conducting element in the form of a planar metal film to which a homogeneous mixture of the active material of the positive electrode is applied on both sides. In the present embodiment, the negative electrode comprises a compressible conducting element onto which the active material of the negative electrode is deposited on both sides when the battery cell is charged.

The cavity of the housing 102, insofar as it is not occupied by the electrode arrangement 105, is filled with an electrolyte (not shown). The positive and negative electrodes of the electrode arrangement 105 are connected via corresponding terminal lugs 106 for the positive electrode and 107 for the negative electrode to the terminal contacts 108 for the positive electrode and 109 for the negative electrode, the lugs allowing for the rechargeable battery cell 101 to be electrically connected. As an alternative to the electrical connection of the negative electrode shown in FIG. 4, using the terminal lug 107 and the terminal contact 109, the electrical connection of the negative electrode may also be accomplished via the housing 102.

### Example 1: Production of Six Embodiments 1, 2, 3, 4, 5, and 6 of an SO₂-Based Electrolyte for a Battery Cell

For the experiments described below, six embodiments 1, 2, 3, 4, 5, and 6 of the SO₂-based electrolyte (hereinafter referred to as electrolytes 1, 2, 3, 4, 5, and 6) were prepared. For this purpose, five different first conductive salts according to formula (I) were first produced according to a production process described in the following documents [V8], [V9], [V10] and [V11]:
[V8] “I Krossing, Chem. Eur. J. 2001, 7, 490;
[V9] S. M. Ivanova et al., Chem. Eur. J. 2001, 7, 503;
[V10] Tsujioka et al., J. Electrochem. Soc., 2004, 151, A1418;
[V11] Wu Xu et al., Electrochem. Solid-State Lett. 2000, 3, 366-368.

These six different, first conductive salts according to formula (I) are referred to below as compounds 1, 2, 3, 4, 5, and 6. They come from the family of polyfluoroalkoxyaluminates.

Compounds 1, 2, 3, 4 and 5 were prepared according to the following reaction equations starting from LiAlH₄ and the corresponding alcohol R—OH with R¹═R²═R³═R⁴ in hexane (cf. documents [V8], [V9] and [V10]).

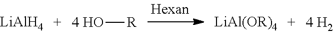

The chelate complex was produced starting from the corresponding HO—R—OH diol according to a preparation method described in document [V11].

This way, the compounds 1, 2, 3, 4, 5, and 6 shown below were formed with the empirical or structural formulas:

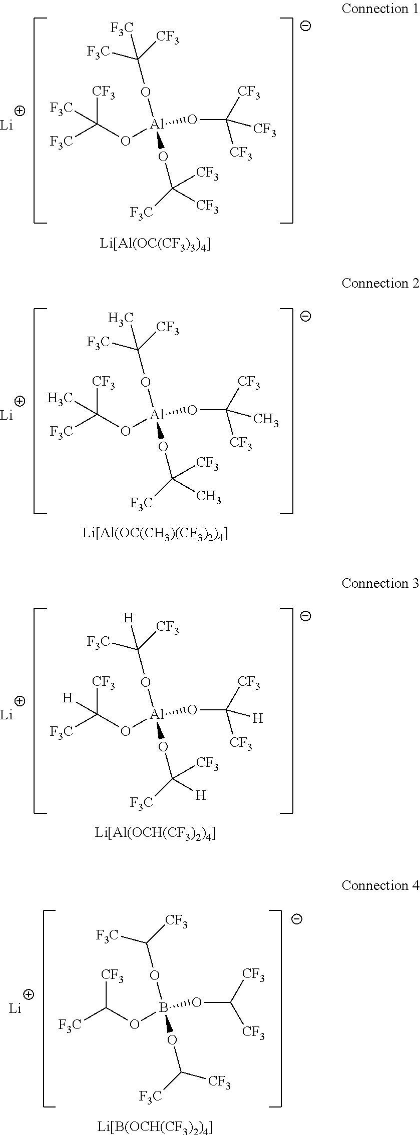

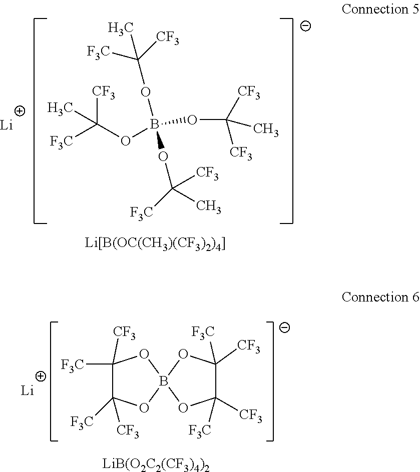

For purification purposes, compounds 1, 2, 3, 4, 5, and 6 were first recrystallized. This removed any existing residues of the starting material LiAlH₄ from the first conductive salt since this starting material could possibly lead to sparking with any traces of water present in SO₂.

Then, compounds 1, 2, 3, 4, 5, and 6 were dissolved in SO₂. It was found that compounds 1, 2, 3, 4, 5, and 6 dissolve well in SO₂.

The electrolytes 1, 2, 3, 4, 5, and 6 were produced at low temperature or under pressure according to the process steps 1 to 4 listed below:
1) Provide the respective compound 1, 2, 3, 4, 5, and 6, each in a pressure piston with riser pipe;
2) Evacuate the pressure pistons;
3) Add liquid SO₂ and
4) Repeat steps 2+3 until the target amount of SO₂ has been added.

The concentration of compounds 1, 2, 3, 4, 5, and 6 in electrolytes 1, 2, 3, 4, 5, and 6 was 0.6 mol/L (molar concentration based on 1 liter of the electrolyte), unless otherwise stated in the experiment description. The experiments described below were carried out with the electrolytes 1, 2, 3, 4, 5, and 6.

### Example 2: Production of Full Cells

The full cells used in the experiments described below are rechargeable round battery cells with a negative electrode and a positive electrode separated by a separator element. The electrodes with the separator element are wound in the round cell. The housing is cylindrical. The positive electrodes comprised an active material, a conductivity unit, and a binding agent. The active material of the positive electrode is named in each experiment. The negative electrode contained metallic lithium as the active material, which was deposited or already present on the conducting element of the negative electrode. Which type of separator element and conducting element were used in the full cells is specified in the respective experiment. The full cells were each filled with the electrolyte required for the experiments.

Several identical full cells, i.e., two to four, were produced for each experiment. The results presented in the experiments are in each case the mean values from the measured values obtained for the identical full cells.

### Example 3: Measurement in Full Cells

### Discharge Capacity

For measurements in full cells, e.g., the discharge capacity is determined by using the number of cycles. To this end, the full cells are charged with a specific charging current up to a specific upper potential. The corresponding upper potential is maintained until the charging current has dropped to a specific value. The discharge then takes place at a specific discharge current down to a specific discharge potential. This charging method is referred to as an I/U charging. This process is repeated depending on the desired number of cycles.

The upper potentials or the discharge potential and the respective charging or discharging currents are listed in the experiments. The value to which the charging current must have dropped is described in the experiments as well.

The term “upper potential” is used synonymously with the terms “charging potential,” “charging voltage,” “end of charge voltage” and “upper potential limit.” These terms describe the voltage/potential to which a cell or battery is charged with the help of a battery charger.

The battery is preferably charged at a current rate of C/2 and at a temperature of 22°° C. By definition, the nominal capacity of a cell is charged or discharged in one hour at a charge or discharge rate of 1C. A charge rate of C/2 therefore means a charge time of 2 hours.

The term “discharge potential” is used synonymously with the term “lower cell voltage.” This is the voltage/potential to which a cell or battery is discharged with the help of a battery charger.

The battery is preferably discharged at a current rate of C/2 and at a temperature of 22°° C.

The discharge capacity is obtained from the discharge current and the time until the discharge termination criteria are met. The associated figures show mean values for the discharge capacities as a function of the number of cycles. These mean values of the discharge capacities are each expressed as a percentage of the nominal capacity.

The ratio of the discharge capacity Qₑₙₜ and the charge capacity Q_{lad} indicates the cycle efficiency Z=Qₑₙₜ/Q_{lad}. The charging capacity is determined by the charging parameters. The discharge capacity is determined for each cycle as described above.

### Comparative Experiments: Cycles of Full Cells With Non-Compressible Separator Elements Compared With Prior Art Full Test Cells (See [V7] ) with Non-Compressible Separator Elements

The full test cells used in [V7] were rechargeable battery cells with two negative electrodes and one positive electrode in a prismatic housing. Further information on the materials or cycle parameters can be found in [V7]. The charging capacity of these full test cells was 0.08 Ah. This corresponds to a surface capacity of 4 mAh/cm². The full test cell was successfully charged and discharged several times (see [V7] FIG. 12).

Building on the positive results of the full test cell from [V7], four wound full cells were tested.

As described in Example 2, the full cells are wound cells in a cylindrical housing with a positive electrode with lithium nickel manganese cobalt oxide as the active material and a negative electrode made of metallic lithium, which is deposited as the active material on both sides of the conducting element of the negative electrode during the charging process. The full cells were filled with the electrolyte 1 described in Example 1. The charging capacity of the full cells is 7.5 Ah. Both the electrodes of the full cells and the electrodes of the full test cells from [V7] were separated by a non-compressible separator element. (Polymer with ceramic coating).

The full cells were each charged with a charging current of 0.1 mA/cm² up to a potential of 4.7 volts. Surprisingly, however, none of the full cells reached the charging capacity of 7.5 Ah. Two full cells had a short circuit before the end of the charging process. The housing of two other full cells was damaged during the charging process. At the time the short circuit occurred or the cells opened, only a surface capacity of approx. 2.0-2.5 mAh/cm² was reached.

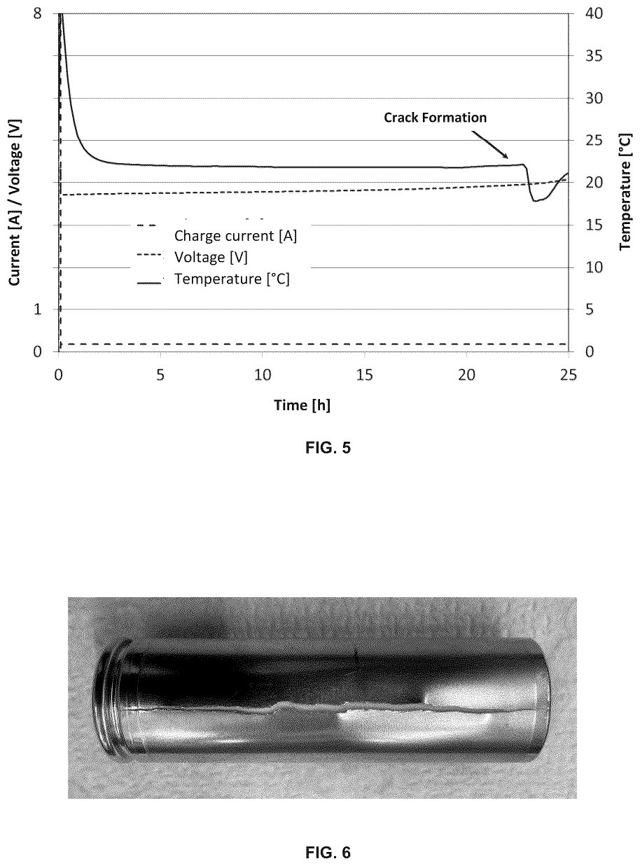

FIG. 5 shows the charging current, voltage and temperature over time for a full cell whose housing was damaged during the charging process. In the temperature curve, the damage to the housing can be seen as a drop in temperature.

FIG. 6 shows the housing of the full cell, which was damaged by a crack and could therefore no longer be used.

Surprisingly, the positive results of the prismatic full test cell could not be transferred to the cylindrical full cell, although cylindrical housings are more pressure-stable than prismatic housings due to the geometric conditions.

### Experiment 1: Calculation of the Components

For the tests, a compressible separator element made of a composite of a polymer membrane and a polymer fleece, both made of polypropylene, was selected. The compressible separator element has a thickness p of 51 μm in the uncompressed state.

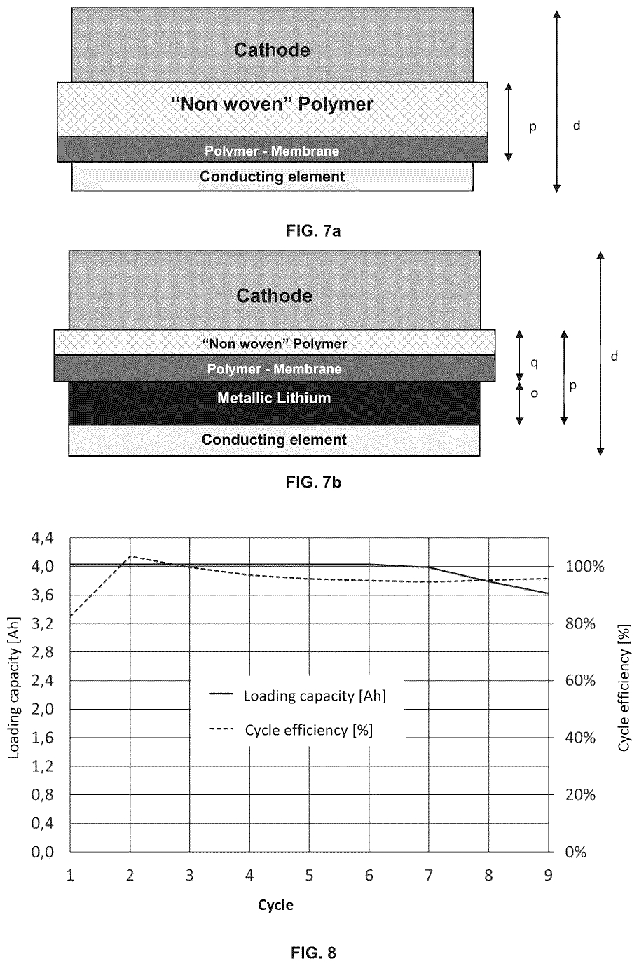

FIG. 7a shows schematically a battery cell with a conducting element, the compressible separator element and a cathode. The battery cell has the thickness ratios of the individual components are not a reflection of the true conditions in a battery cell and are only shown in a simplified manner. The battery cell is not charged, so there is no lithium on the conducting element. The compressible separator element with thickness p can be seen between the cathode and the conducting element. The separator element is not compressed in FIG. 7a.

Measurements showed that a maximum compression of the separator element to a thickness q of 25 μm is possible. After the maximum compression, a gap with a height of 26 μm remains.

A lithium deposition of 4 mAh/cm² corresponding to a deposition thickness o of 19 μm is planned.

This results in the following: o+q<=p

19 μm+25 μm=44 μm<=51 μm

Accordingly, there should be enough space to deposit 4 mAh/cm² of lithium on the conducting element.

FIG. 7b shows a schematic view of a charged cell in which lithium metal is deposited on the conducting element. The compressible separator element is compressed to the thickness q and provides space for the lithium metal with the thickness o.

The total thickness d of the battery cell has not changed despite the lithium deposition due to the compressible separator element. A pressure build-up inside the housing is therefore not to be expected and a stable charging and discharging behavior should be achieved.

### Experiment 2: Cycling of Full Cells with a Compressible Separator Element

As described in Example 2, the full cells are wound cells with a positive and a negative electrode. The charging capacity of these full cells is 4.00 Ah. The electrodes were separated by the compressible separator element described in Experiment 1. The positive electrode had lithium nickel manganese cobalt oxide as the active material. During the charging process, metallic lithium was deposited as an active material on both sides of the conducting element of the negative electrode. The full cell was filled with the electrolyte 1 described in Example 1.

The full cell was charged with a current of 0.1 mA/cm² up to a potential of 4.4 volts and until a charging capacity of 4.00 Ah was reached, corresponding to an area capacity of 4 mAh/cm². The discharge was then carried out with a current of 0.5 mA/cm² until a potential of 2.9 volts was reached.

In contrast to the full cell without a compressible separator element (see comparison experiment), which could not be fully charged, the full cell with a compressible separator element can be charged and discharged several times. FIG. 8 shows the charging capacity and cycle efficiency for nine cycles.

The charging capacity remains constant at approx. 4.0 Ah for the first seven cycles and then drops slightly. The cycle efficiency is around 95%. These are excellent results for a rechargeable battery cell. The values theoretically calculated in Experiment 1 describe the conditions in a full cell well. There is no pressure build-up inside the housing and a stable charging and discharging behavior, as shown in FIG. 8, is achieved.

### Experiment 3: Determination of the Conductivities of Electrolytes 1, 3, 4, 5, and 6

To determine the conductivity, electrolytes 1, 3, 4, 5, and 6 were prepared with different concentrations of the compounds 1, 3, 4, 5, and 6. For each concentration of the different compounds, the conductivities of the electrolytes were determined with a conductive measurement method. After having been brought to the correct temperature, a four-electrode sensor was placed into the solution and measured in a measuring range of 0.02-500 mS/cm.

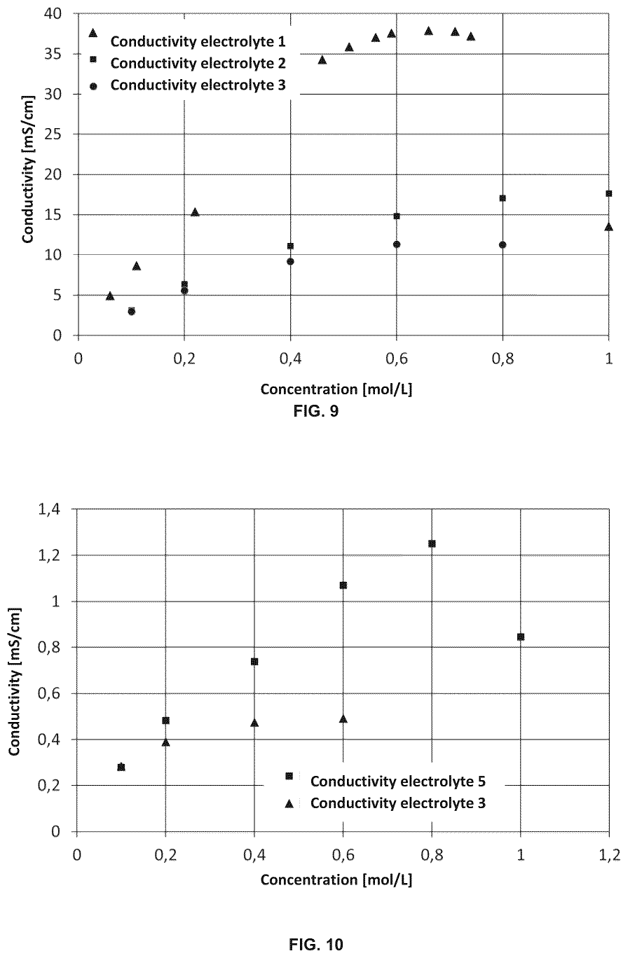

FIG. 9 shows the conductivities of electrolytes 1, 4, and 6 as a function of the concentration of compounds 1, 4, and 6. In the case of electrolyte 1, a conductivity maximum can be seen at a concentration of compound 1 of 0.6 mol/L-0.7 mol/L with a value of approx. 37.9 mS/cm. In comparison, the organic electrolytes known from prior art, such as, e.g., LP30 (1 M LiPF6/EC-DMC (1:1 by weight)) have a conductivity of only approx. 10 mS/cm. In the case of electrolyte 4, a maximum of 18 mS/cm is achieved at a conductive salt concentration of 1 mol/L. Electrolyte 6 shows a maximum of 11 mS/cm at a conductive salt concentration of 0.6 mol/L.

FIG. 10 shows the conductivities of electrolytes 3 and 5 as a function of the concentration of compounds 3 and 5. For electrolyte 5, a maximum of 1.3 mS/cm is achieved at a conductive salt concentration of 0.8 mol/L. Electrolyte 3 shows its highest conductivity of 0.5 mS/cm at a conductive salt concentration of 0.6 mol/L. Although electrolytes 3 and 5 show lower conductivities, it is quite possible to charge and discharge half a test cell.

Since electrolyte 1 displays the best conductivity, the full cell experiments were carried out with this electrolyte. Since the conductivities of the other electrolytes also show sufficient values, no change is to be expected in the behavior of full cells with the other electrolytes, e.g., in experiments comparable to Experiment 2.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A rechargeable battery cell comprising an active metal, at least one positive electrode having a planar conducting element, at least one negative electrode having a planar conducting element, at least one separator element, a housing and one electrolyte, wherein the electrolyte is based on SO₂ and contains at least one first conductive salt which has the formula (I) 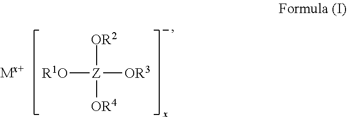
wherein
M is a metal selected from the group consisting of alkali metals, alkaline earth metals, group 12 metals of the periodic table of the elements, and aluminum;
x is an integer from 1 to 3;
the substituents R¹, R², R³ and R⁴ are selected independently from one another from the group consisting of C₁-C₁₀ alkyl, C₂-C₁₀ alkenyl, C₂-C₁₀ alkynyl, C₃-C₁₀ cycloalkyl, C₆-C₁₄ aryl and C₅-C₁₄ heteroaryl, wherein the aliphatic, cyclic, aromatic and heteroaromatic groups may be unsubstituted or substituted;
Z is aluminum or boron; and
at least two of the substituents R¹, R², R³ and R⁴ can jointly form a chelate ligand which is coordinated to Z; and
wherein the negative electrode comprises the active metal in metallic form at least in the charged state of the rechargeable battery cell; and
wherein a space is arranged within the housing for receiving the active metal deposited during the charging process, said space being formed by a compressible structure which is compressed by the deposited active metal.

2. The rechargeable battery cell according to claim 1, wherein the sum of the thickness of the deposited layer of active metal and the thickness of the compressed structure in the compressed state is less than or equal to the thickness of the compressible structure in the uncompressed state.

3. The rechargeable battery cell according to claim 1, wherein the compressible structure returns to its uncompressed state after the dissolution of the previously deposited active metal.

4. The rechargeable battery cell according to any of claim 1, wherein the compressible structure is formed by at least one conducting element and/or by at least one separator element.

5. The rechargeable battery cell according to claim 4, wherein the compressible structure is formed by at least one separator element.

6. The rechargeable battery cell according to claim 4, wherein the compressible separator element comprises an organic polymer membrane and at least one nonwoven layer.

7. The rechargeable battery cell according to claim 1, wherein the conducting element of the negative electrode and the positive electrode are formed:
either planar in the form of a metal sheet or a metal foil or
three-dimensionally in the form of a porous metal structure, or
as a compressible conducting element.

8. The rechargeable battery cell according to claim 7, wherein the conducting element of the negative electrode and the positive electrode are formed of a metal foam.

9. The rechargeable battery cell according to claim 7, wherein the positive electrode is formed as a compressible conducting element formed from a compressible polymer selected from the group consisting of polypropylene, polyethylene, polyurethane, polystyrene, polyamide, polyethylene terephthalate or polyvinylidene fluoride.

10. The rechargeable battery cell according to claim 9, wherein the compressible polymer of the conducting element is coated with a metal on one or both sides.

11. The rechargeable battery cell according to claim 10, wherein the coating comprises aluminum or copper.

12. The rechargeable battery cell according to claim 1, wherein at least during the first charging process, a part of the metallic active metal is deposited with a current selected from the group consisting of: at least 3.0 mA/cm², at least 3.5 mA/cm², at least 4.0 mA/cm², at least 4.5 mA/cm², at least 5.0 mA/cm², at least 5.5 mA/cm² and at least 6.0 mA/cm², based on the one-sided surface of the negative electrode.

13. The rechargeable battery cell according to claim 1, wherein the part of the metallic lithium that is deposited during the first charging process with a current at least 3 mA/cm² based on the one-sided surface of the negative electrode has a weight selected from the group consisting of: at least 3% by weight, at least 5% by weight, at least 10% by weight, at least 30% by weight, at least 50% by weight, at least 70% by weight, at least 90% by weight and at least 100% by weight based on the total amount of active metal deposited.

14. The rechargeable battery cell according to claim 1, wherein the active metal in metallic form is found on the conducting element of the negative electrode before the rechargeable battery cell is charged for the first time.

15. The rechargeable battery cell according to claim 1, wherein the first conductive salt is selected from the group consisting of:
an alkali metal;
an alkaline earth metal;
a metal from group 12 of the periodic table; and
aluminum.

16. The rechargeable battery cell according to claim 15, wherein the first conductive salt is lithium or sodium.

17. The rechargeable battery cell according to claim 15, wherein the first conductive salt is calcium.

18. The rechargeable battery cell according to claim 15, wherein the first conductive salt is zinc or aluminum.

19. The rechargeable battery cell according to claim 1, wherein at least one of the substituents R¹, R², R³ and R⁴ of the first conductive salt is a CF₃ group or an OSO₂—CF₃ group.

20. The rechargeable battery cell according to claim 1, wherein the first conductive salt is selected from the group consisting of:

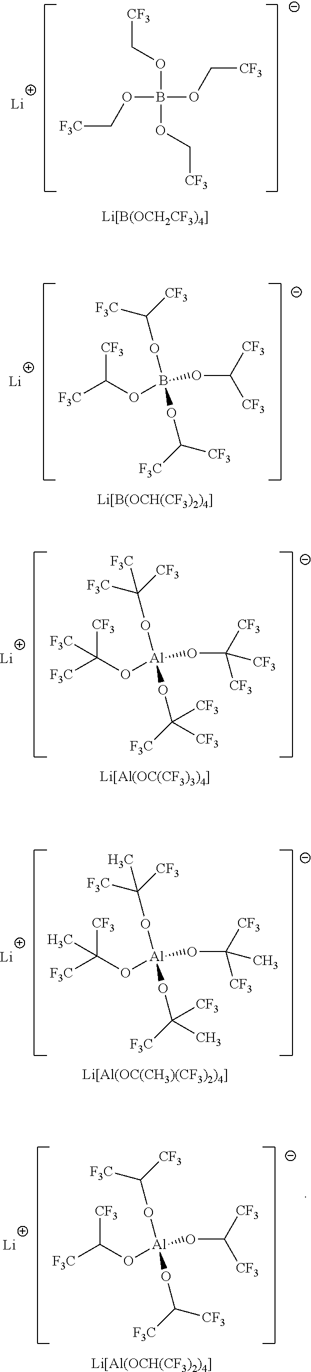

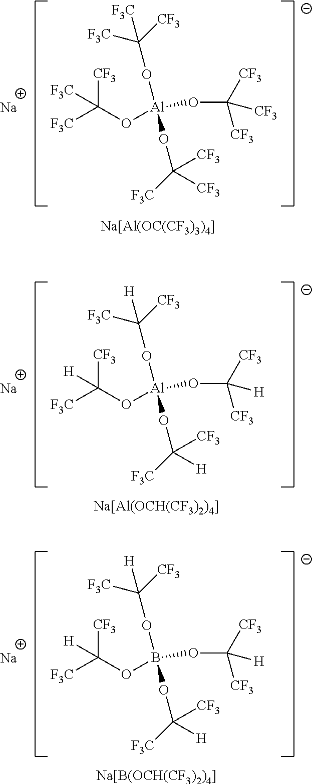

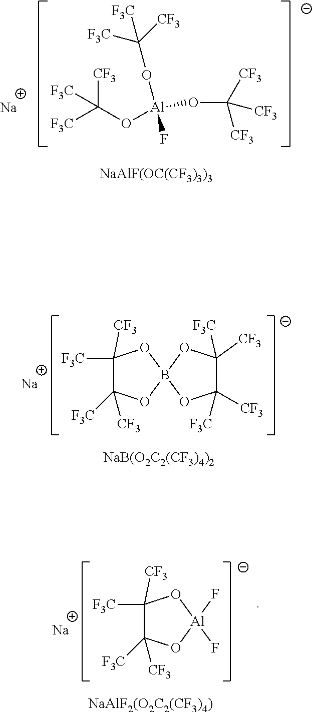

21. The rechargeable battery cell according to claim 1, wherein the first conductive salt has the following formula:

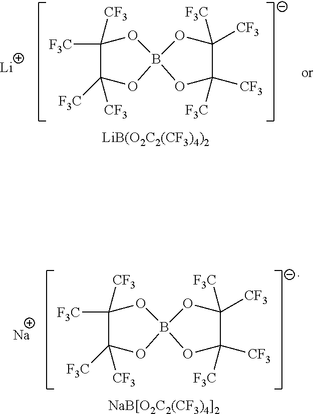

22. The rechargeable battery cell according to claim 1,wherein the electrolyte comprises:
5 to 99.4 wt % sulfur dioxide,
0.6 to 95 wt % of the first conductive salt,
0 to 25 wt % of the second conductive salt, and
0 to 10 wt % of the additive,
relative to the total weight of the electrolyte composition.

23. The rechargeable battery cell according to claim 1, wherein the molar concentration of the first conductive salt is in a range selected from the group consisting of: 0.01 mol/L to 10 mol/L, 0.05 mol/L to 10 mol/L, 0.1 mol/L to 6 mol/L, and 0.2 mol/L to 3.5 mol/L based on the total volume of the electrolyte.

24. The rechargeable battery cell according to claim 1, wherein the electrolyte contains an amount of SO₂ selected from the group consisting of: at least 0.1 mole of SO₂, at least 1 mole of SO₂, at least 5 moles of SO₂, at least 10 moles of SO₂ and at least 20 moles of SO₂ per mole of conductive salt.
